(19) United States
(12) Patent Application Publication
(10) Pub. No.: US 2023/0416552 A1
(43) Pub. Date: Dec. 28, 2023

(54) FORMATION OF ELECTRICALLY CONDUCTIVE LAYERS AT ROOM TEMPERATURE USING SILVER NANOPARTICULATE PROCESSING AND INKS FOR FORMING THE LAYERS

(71) Applicant: C3 Nano, Inc., Hayward, CA (US)

(72) Inventors: Xiqiang Yang, Hayward, CA (US); Arthur Yung-Chi Cheng, Newark, CA (US); Michael Fang, Hayward, CA (US); Pei-Kang Liu, Claremont, CA (US); Ajay Virkar, San Mateo, CA (US)

(21) Appl. No.: 18/212,297

(22) Filed: Jun. 21, 2023

Related U.S. Application Data
(60) Provisional application No. 63/354,465, filed on Jun. 22, 2022.
(60) Provisional application No. 63/407,310, filed on Sep. 16, 2022.

(51) Int. Cl. C09D 11/52; C09D 11/037; C09D 11/033; C09D 11/14

(52) U.S. Cl. CPC C09D 11/52; C09D 11/037; C09D 11/033; C09D 11/14

(57) ABSTRACT

Room temperature processing has successfully resulted in highly conductive coatings formed from silver nanowires with a cellulose binder. The conductive coatings can be formed with silver salts to fuse the silver nanowires into a unitary fused metal nanostructured network. Even without added silver salts, low sheet resistance values can be obtained. Room temperature processing can be effective over a range of transmittance values from highly transparent to modestly transparent to translucent to opaque. The ability to form the transparent coatings opens the processing to a wide range of substrates that are not processible with higher process temperatures.

### CROSS REFERENCE TO RELATED APPLICATIONS

This application claims priority to co-pending U.S. provisional patent application 63/354,465 filed Jun. 22, 2022 to Yang et al., entitled “Formation of Fused Silver Nanostructured Networks With Room Temperature Processing and/or on Temperature Sensitive Materials,” and U.S. provisional patent application 63/407,310 filed Sep. 16, 2022 to Yang et al., entitled “Formation of Electrically Conductive Layers at Room Temperature Using Silver Nanoparticulate Processing and Inks for Forming the Layers,” incorporated herein by reference.

### FIELD OF THE INVENTION

The invention relates to room temperature processing to form thin electrically conductive coatings, which may be transparent. The invention further relates to some silver nanowire inks for forming electrically conductive coatings as well as electrically conductive coatings on temperature sensitive substrates.

### BACKGROUND OF THE INVENTION

Functional films can provide important functions in a range of contexts. For example, electrically conductive layers can be important for the dissipation of static electricity when static can be undesirable or dangerous. Transparent conductive films can be used as electrodes. High quality displays can comprise one or more transparent conductive layers.

Transparent conductors can be used for several optoelectronic applications including, for example, touch-screens, liquid crystal displays (LCD), flat panel display, organic light emitting diode (OLED), solar cells and smart windows. Historically, indium tin oxide (ITO) has been the material of choice due to its relatively high transparency at high conductivities. There are however several shortcomings with ITO. For example, ITO is a brittle ceramic, which needs to be deposited using sputtering, a fabrication process that involves high temperatures and vacuum and therefore is relatively slow and not cost effective. Additionally, ITO is known to crack easily on flexible substrates. Newer portable electronic devices are pushing into thinner formats and flexible formats.

### SUMMARY OF THE INVENTION

In a first aspect, the invention pertains to a method for forming a conductive layer comprising the step of depositing a metal nanowire ink onto an inert surface to form a coating and drying the coating at room temperature to form a conductive film. The ink can comprise from about 0.001 wt % to about 4 wt % metal nanowires and from about 0.05 wt % to about 5 wt % polysaccharide. The conductive film can have a sheet resistance of no more than about 1000 Ohms/sq.

In a further aspect, the invention pertains to an ink for forming a conductive layer, the ink comprising from about 0.001 wt % to about 4 wt % metal nanowires and from about 0.05 wt % to about 5 wt % of a hydroxy alkyl-functionalized polymeric binder, aqueous solvent comprising from about 20 vol % to about 100 vol % of a C₁ to C₁₀ alcohol, and no more than about 0.001 wt % of a surfactant.

In another aspect, the invention pertains to a method for forming an electrically conductive coating, the method comprising the steps of applying a silver nanoparticulate ink to a substrate surface to form a wet coating, and drying the wet coating at a temperature no more than 60° C. to form a dry coating having a sheet resistance of no more than 25 Ohms/sq. The silver nanoparticulate ink can comprise an aqueous solvent, silver nanoparticulates with no more than 85 wt % silver nanowires with an average diameter of 50 nm or less and an aspect ratio of 10 or more, and a cellulose binder.

In other aspects, the invention pertains to a silver nanoparticulate ink comprising an aqueous solvent, silver nanoparticulates with no more than 85 wt % silver nanowires with an average diameter of 50 nm or less and an aspect ratio of 10 or more, and a cellulose binder, wherein the weight ratio of cellulose to silver nanoparticulates is from about 0.05 to about 3.

### BRIEF DESCRIPTION OF THE DRAWINGS

FIG. 1 is a fragmentary side view of a film with a conductive layer and various additional transparent layers on either side of the conductive layer.

FIG. 2 is a schematic plot showing relative differences in processing temperature versus time, energy and cost, for contemporary electrode technologies.

FIG. 3 is a plot of the sheet resistance for ink coatings dried with cool air at about 21° C. as a function of the level of AgOAc present in the ink used to prepare the coatings.

FIG. 4 is a plot of the sheet resistance for ink coatings dried for 2 minutes at about 120° C. as a function of the level of AgOAc present in the ink used to prepare the coatings.

FIG. 5 is a plot of percent total transmittance as a function of sheet resistance for ink coatings including AgF and dried at ambient conditions.

FIG. 6 is a plot of percent haze as a function of sheet resistance for an ink coating including AgF and dried at ambient conditions.

FIG. 7A is a photograph showing measurement of resistance for an ink coating of the present invention, on a medical grade polyurethane substrate, dried at ambient conditions.

FIG. 7B is a photograph showing measurement of resistance for an ink coating of the present invention, on a medical bandage, dried under ambient conditions.

FIG. 7C is a photograph showing measurement of resistance for an ink coating of the present invention, on a leaf, dried under ambient conditions.

FIG. 7D is a photograph showing measurement of resistance for an ink coating of the present invention, on a Ziploc® bag, dried under ambient conditions.

FIG. 7E is a photograph showing measurement of resistance for an ink coating of the present invention, on a shrink wrap substrate, dried under ambient conditions.

FIG. 7F is a photograph showing measurement of resistance for an ink coating of the present invention, on the adhesive layer of a Scotch™ Tape substrate, dried under ambient conditions.

FIG. 7G is a photograph showing measurement of resistance for an ink coating of the present invention, formed as a circuit on a polyethylene terephthalate substrate, dried under ambient conditions.

FIG. 7H is a photograph showing measurement of resistance for an ink coating of the present invention, formed as a circuit on a packaging cardboard substrate, dried under ambient conditions.

FIG. 8 shows a plot of percent haze as a function of the inverse of sheet resistance, for ink coatings prepared with inks comprising different fusing agents or without fusing agents, dried using cool air only or at room temperature followed by 2 minutes at about 120° C.

FIG. 9 shows a bar graph illustrating comparison of sheet resistance values obtained for the ink coatings of FIG. 8.

### DETAILED DESCRIPTION OF THE INVENTION

Readily processable silver nanowire containing inks can be formed into thin layers of electrically conductive material at room temperature. In some embodiments, the conductive coatings can be transparent, even highly transparent with very low scattering. Good electrical conductivity can be achieved with or without fusing the nanowires, but fusing generally is desirable to form transparent coatings with good mechanical properties, improved stability and better optical characteristics. Nanowires can be fused into fused metal nanostructured networks, which are unitary structures with desirable properties. Processing generally involves inks containing an appropriate amount of polysaccharide binders, such as cellulose ethers. Generally, the inks are amenable to various coating processes, such as slot coating, dip coating, spray or jet-deposition, or the like, and can be applied to a range of substrate surfaces. The room temperature processing can advantageously open the processing to a range of previously inappropriate substrate materials, and can also provide energy and cost savings.

Silver nanowires have been successfully produced into high optical quality transparent conductive coatings with desirable mechanical properties, such as stretchability and stability against repeated folding and unfolding, while maintaining electrical conductivity. Processing extensions described herein can maintain the excellent optical qualities as well as extend desirable processing of conductive coatings for formation of less transparent or nontransparent conductive thin films. Dispersions or inks of silver nanowires can be deposited on a surface and processed into a conductive coating. Under appropriate process conditions, a resulting conductive coating, optionally transparent, can be desirable due to its mechanical properties, such as flexibility, formability, combinations of these features, or other aspects of the conductive coating. In the art, “nanoparticle” has taken on extra duty to refer specifically to roughly spherical nanostructures as well as to refer to nanostructures of any shape. To lessen the burden on this term, herein “nanoparticulate” is used to refer to nanostructures of any shape, and “nanoparticle” refers only to roughly spherical nanostructures, i.e., ratios of diameters along the three principal axes are on average less than about 2. With respect to transparent coatings, the use of the nanowires to form transparent conductive coatings can have significant application in devices with displays and touch sensors. With higher metal loadings, reduced electrical resistance is found, while the transmittance of visible light is reduced. Even well purified silver nanowires have some minor portion of other silver nanoparticulate contaminants. and in the context of less transparent or non-transparent applications, the nanowires may be mixed with somewhat greater weight fraction of other nanoparticulates. With the capability of processing at room temperature, formation of non-transparent conductive layers can be desirably formed on a temperature sensitive substrate. Inclusion of additional nanoparticles may be desirable to improve conductivities or reduce costs (less purification) for optically insensitive coatings. Thus, the processing described herein may be practically applied to a broader range of applications of electrically conductive coatings. The room temperature processing was initially described in U.S. provisional patent application 63/354,465 filed Jun. 22, 2022 to Yang et al., entitled “Formation of Fused Silver Nanostructured Networks With Room Temperature Processing and/or on Temperature Sensitive Materials,” incorporated herein by reference.

In some embodiments, transparent electrically conductive elements, e.g., coatings, based on metal comprise a sparse metal conductive layer. The conductive layers are generally sparse to provide desired amount of optical transparency through the conductive structure rather than around the conductive structure, so the coverage of the metal generally has significant, although microscopic, gaps over the layer of the conductive element. For example, transparent electrically conductive coatings can comprise metal nanowires deposited along a layer where sufficient contact can be provided for electron percolation to provide suitable conduction pathways. The one-dimensional morphology of nanowires is conducive to forming sparse metal conductive layers. In embodiments of particular interest, the transparent electrically conductive coating can comprise a fused metal nanostructured network, which has been found to exhibit desirable electrical, optical and mechanical properties. In the fused structure, unlike the unfused structure, electrons can conduct through the network instead of hopping between separate nanowires. Conductivity referenced herein refers to electrical conductivity unless specifically indicated otherwise. Though, the electrically conductive coatings described can also serve as transparent heaters via joule heating under applied voltages. The structures described herein can also be effective for forming non-transparent conductive coatings processed at room temperature using solution coating processes.

Applicant's application of the fusing process can be controlled to selectively deposit metal at junctions between the metal nanowires or to form a fused mass for less conductive structures regardless of the nanoparticulates. For forming fused metal nanostructures networks, the fusing process can be controlled to deposit a desired amount of silver associated with the junctions. The systems can be poised to provide for thermodynamic driving of the fusing to take place primarily at the junctions between neighboring metal nanowires that are components that are formed into the fused metal nanostructured network. Following fusing, a unitary structure is formed that has been named a fused metal nanostructured network, and the original metal nanowires within the conductive structure lose their individual identity. Evidence suggests that the fusing metal merges the original individual nanowires to reduce or eliminate junction resistance, which would involve a joining of the individual nanowires. For commercial products, it is desirable to improve the durability of the transparent conductive coatings under a range of real-world conditions. These principles follow for the room temperature processing described herein.

For transparent coatings, the fusing process to form a fused metal nanostructured network has been found to result in highly transparent and highly conductive structures with very low haze when good quality silver nanowires are used. The fused metal nanostructured networks have been shown to have very good stability under accelerated wear conductions using appropriate stabilizers. The addition of noble metal ions, such as silver, in the overcoat can provide an additional level of stabilization, as described in published U.S. patent application 2021/0151216 to Yang et al., entitled “Coatings and Processing of Transparent Conductive Films for Stabilization of Sparse Metal Conductive Layers,” incorporated herein by reference.

In Applicant's prior work based on thermodynamically driven fusing, this processing was performed at low temperature in a relative sense. Heat though was used to control drying rate and to control the fusing process and to accelerate other kinetic processes, reaction rates and diffusion. In the context of commercial processing of conductive films, roll-to-roll processing was developed using existing process equipment to provide desired heating with consistent product quality, and the modest heating was straightforward to implement. Nevertheless, the heating does consume energy and does provide constraints on substrates. In particular, a myriad of plastic, polymeric, and biologically relevant substrates exhibit low glass transition and or low melting temperatures which require low processing temperatures.

When faced with processing of particularly heat sensitive substrates, an effort was made to lower the process temperature. Surprisingly, systems were developed that achieved low sheet resistances with room temperature processing with a single ink deposition and with fast results. These results are again consistent with poised thermodynamic systems that can be guided to achieve desired results with application of a bit of faith and appropriately tuned chemical combinations, which were discovered as described herein. With the achievement of these results, it can be recognized that desirable processing improvements could also be applicable to applications with less demanding optical properties or even non-transparent applications with advantageous effect.

As the results presented herein demonstrate, the composition of the silver nanowire inks determines the effectiveness of forming a good conductive layer with or without fusing of the nanowires into a fused metal nanostructure network or other fused conductor, and at temperatures no more than about 60° C., in additional embodiments no more than about 55° C., in other embodiments no more than about 50° C., in some embodiments no more than about 40° C., and in further embodiments no more than about 30° C., especially at room temperature. Chemical fusing is effective to further lower the sheet resistance, and approaches are described to achieve good fusing at room temperatures. For the purposes herein, room temperature can be considered to be from about 16° C. to about 28° C., although in some embodiments it may be appropriate to consider a range for room temperature to be from about 18° C. to about 26° C., from about 20° C. to about 25° C. or other appropriate subranges within the broad range provided. A person of ordinary skill in the art will recognize that additional ranges of temperature within the explicit ranges above are contemplated and are within the present disclosure. Drying can be facilitated by gentle blowing with or without low heating of the air.

Since initial efforts to use silver nanowires for forming conductive coatings, effort has been devoted to decreasing the sheet resistance resulting from junction resistance between the nanowires. As demonstrated in Applicant's initial fusing work, simple deposition of nanowire dispersions generally results in very high sheet resistance values, such as in the megaOhm/sq. range. See, for example, the '207 patent cited below. Various efforts have been used in that effort, such as application of pressure and use of various energy sources. A corresponding concern is the processability of the nanowire inks to form consistent good quality coatings. Applicant made an important leap in this effort through the invention of chemical fusing, which can be effective even if the unfused structure has a very high sheet resistance.

Ancillary to the fusing process, Applicant introduced process aids, especially binders, to provide for commercially processible and reproducible coating properties. To avail themselves of these process aids consistent with achieving fusing, Applicant discovered that binder selection was important. Hydrophilic binders were used with particular success found with polysaccharide binders. Due to widespread commercial use in many applications including similar applications, cellulose based binders were convenient polysaccharides to adopt. While not explicitly pointed out, Applicant's earlier work in the '968 patent, cited below, discovered considerable improvements in sheet resistance using polysaccharide binders without applying pressure or any further processing steps. While still not fully understood, the appropriate polymers are able to reduce junction resistance to roughly the degree as applying extremely high pressures, although chemical fusing still provides significant further reduction due to joining of the silver nanowires in forming an integral structure. While not wanting to be limited by theory, this observation strongly suggests some interactions between the polysaccharide binders and the metal nanowires allow for the nanowires to be appreciably close in proximity such that the nanowires can be electrically associated with one another and good conductivity can be achieved in networks of nanowires and polysaccharide binders provided the correct chemistries and processing are employed. Without wanting to be limited by theory, this evidence also suggests some driving force and beneficial assembly on the nanoscale between the polymer and the nanowires which tends to increase silver-silver contact while also providing significant surface association of the silver nanowires with the cellulose.

This early work though still involved a modest application of heat. Thus, the results herein demonstrate excellent results without the application of any heat, or very low amounts of heat, whether or not fusing takes place, although fusing results in further improvements. And for even more mysterious reasons, some metal salts seem to inhibit the full room temperature establishment of conductivity if no fusing is induced.

The results presented herein demonstrated that fusing with silver fluoride markedly facilitates fusing relative to silver acetate, and presumably other silver salts, in comparable ink systems using the same nanowires, binders and solvents. Silver fluoride was used as one of several fusing agents tested in the '746 patent and provided comparable results as silver nitrate in the processing described in that patent. The results herein are in comparison with silver acetate fusing agent. Attempts at fusing without any heating with silver acetate did not provide desirable results, as shown in results in the Examples below. With the transition to use of silver fluoride salts, low sheet resistance values are observed herein while providing desirable optical properties. The evidence indicates that the fusing occurred at room temperature with the silver fluoride salt.

For room temperature fusing, the selection of the metal source is significant. In particular silver fluoride (AgF) seems to be the appropriate silver salt. The metal ion source should be soluble. AgF was used in earlier fusing studies described in the '968 patent, and various metal ion sources seemed roughly equivalent under original process conditions. Further testing involving silver acetate as a fusing agent suggested that heating was needed to induce the fusing process. In the current effort, AgF was tested and the amazing result was found that fusing occurred with AgF at room temperature even though additional testing again failed to achieve fusing with AgOAc. Preliminary results with AgNO₃ and AgBF₄ suggest no low temperature fusing with these salts. This is demonstrated in results presented in the Examples below.

The results suggest that even though the anions are believed to be spectators in the relevant reactions, the anion identity may alter the free energies of the reactions, and/or may affect various energetic barriers associated with diffusion and/or reduction, although Applicant does not want to be limited by theory. In any case, the results strongly suggest that these systems are poised near equilibrium to have controlled fusing, so relatively modest changes in free energy have observable effects. Other silver halides are insoluble in relevant solvents, and soluble silver salts generally have anions that would seem to be more similar to the acetate anion.

Even though Applicant has achieved good sheet resistance with room temperature processing with or without fusing, fusing can be effective to reduce sheet resistance without significantly impacting optical properties. Also, fusing is believed to significantly stabilize the conductive coating in embodiments in which the electrically conductive layer is folded or stretched. Thus, for many applications, fusing is highly desirable.

For commercial inks, uniform coating on many substrates involves lowering the surface tension of the inks. Various surfactants can be used in principle, and fluorosurfactants have found popularity due to various pragmatic reasons. Alcohols can serve both as solvents and as wetting agent to form good coatings at higher concentration. With room temperature processing, high alcohol inks have been shown to be effective at forming highly conductive coatings with or without fusing. The alcohols can be chosen to have sufficiently low boiling points to evaporate relatively effectively at room temperature. Alcohol selection may correlate with the amount of alcohol used. While depending on the particular branching structure and placement of the hydroxyl group, boiling points tend to increase with molecular weight, so higher alcohols with more carbon atoms tend toward higher boiling points and correspondingly lower vapor pressure at room temperatures. Generally, alcohols of interest can be C1 to C10 (based on total numbers of carbon atoms in the molecules) alcohols at concentrations from 20 volume percent to 100 volume percent based on solvent liquids.

In general, Applicant's development efforts have provided high quality transparent conductive layers with outstanding optical qualities comparable to indium tin oxide in a material that is bendable and formable such that it can be stretched and repeatedly folded with endurance of the electrical conduction. On the other hand, higher levels of electrical conduction can be achieved with some sacrifice of the transparency. It may even be desirable to make thin electrically conductive coatings that are not transparent using room temperature processing as described herein. These coatings can be formed on materials that can be temperature sensitive substrates and can be flexible. For embodiments without the goal of good optical properties, lower quality silver nanowires can be used, which can tolerate larger proportions of non-nanowire nanoparticulates, such as blends of shapes, blended with nanowires.

Transparent materials are generally ascribed in the art as having an average transmittance of visible light of at least 70%, and this view is adopted herein. Thin transparent conductive coatings can achieve a sheet resistance of roughly less than about 3 Ohms/sq after room temperature processing. On the other end of the transmittance scale, room temperature processing can also achieve highly transparent conductive coatings, with low haze and low L*, reflective scattering, and low sheet resistance. So heating is not needed to achieve the excellent transparent conductive coatings that were achieved previously by Applicant.

Chemical sintering has been discussed in the context of non-transparent structures. Using roughly spherical silver nanoparticles, room temperature sintering was achieved in the context of either forming a pre-coating of a cationic chlorinated polymer (polydiallyldimethylammonium chloride, poly-DADMAC) or the subsequent deposition of a cationic chlorinated polymer. See, published U.S. patent application 2012/0168684 to Magdassi et al. (hereinafter the '684 application), entitled “Process for Sintering Nanoparticles at Low Temperatures,” incorporated herein by reference. Poly-DADMAC is a polyelectrolyte that would not be a desirable component in many contexts. In some embodiments, the '684 application described the inclusion of a sintering salt NaCl in the nanoparticle dispersion, but for these systems, they needed to heat the deposited material to achieve sintering.

The '684 application asserts a broad scope of fusing agent, although many of these clearly do not induce a chemical fusing or effective agglomeration. While the '684 application mentions carboxymethyl cellulose, it does not teach appropriate use of polysaccharide binders, so they do not exemplify good conductivity without chemical sintering based on halide ions and chloride in particular. It is believed that the current work, where fusing of silver nanowires is used to form a fused metal nanostructured network performed at room temperature, is the first formation of a thin electrically conductive coating, sheet resistance below 1000 Ohms/sq., using metal nanoparticulates of any form at room temperature on an inert surface with a single ink deposition, with or without fusing.

Silver can provide excellent electrical conductivity. For forming non-transparent electrically conductive coatings, the characteristics of the metal nanoparticulates can become less significant, although the processing approaches herein are generally based on nanowire processing. When, good transmittance and low scattering are important objectives, silver nanowires can be made more pure to eliminate silver nanoparticles and other non-wire shapes that contribute minimally to conductivity and cause light scattering. Similarly, in the process of making high quality silver nanowires for quality transparent conductive coatings, a significant volume of silver waste is produced that has perfectly suitable silver material except that the silver nanoparticles are of low quality with respect to nanowire characteristics with many spherical nanoparticles, thicker nanowires, short nanorods, nanoplates, and/or odd shaped nanoparticles. For forming thin conductive coatings that are non-transparent, high-quality nanowires are not needed, so that the resulting cost can be significantly lower. At higher silver loadings, any nanoparticles and other non-wire shapes can contribute more to electrical conduction through forming conduction pathways at higher densities.

Improved properties have been found for fused metal nanostructured networks with respect to high electrical conductivity and desirable optical properties with respect to transparency and low haze. Fusing of adjacent metal nanowires can be performed based on chemical processes under commercially appropriate processing conditions.

In particular, a significant advance with respect to achieving electrically conductive coatings based on metal nanowires has been the discovery of well controllable processes to form a fused metal nanostructured network where adjacent sections of the metal nanowires fuse into a unitary structure without distinct nanowires in the conductive network. In particular, it was initially discovered that halide ions can drive the fusing of metal nanowires to form fused metal nanostructures. Fusing agents comprising halide anions were introduced in various ways to successfully achieve the fusing with a corresponding significant drop in the electrical resistance. It should be noted that halide ions in this processing context should not be confused with halide ions used in the nanowire synthesis reactions. Specifically, the fusing of metal nanowires with halide anions has been accomplished with vapors and/or solutions of acid halides as well as with solutions of halide salts. Fusing of metal nanowires with halide sources is described further in U.S. Pat. No. 10,029,916 to Virkar et al., entitled “Metal Nanowire Networks and Transparent Conductive Material,” and U.S. Pat. No. 9,920,207 to Virkar et al. (the '207 patent), entitled “Metal Nanostructured Networks and Transparent Conductive Material,” both of which are incorporated herein by reference.

An extension of the process for forming fused metal nanowire networks was based on reduction/oxidation (redox) reactions that can be provided to result in fused nanowires without destroying the optical properties of the resulting coating. Metal for deposition at the junctions can be effectively added as a dissolved metal salt or can be dissolved from the metal nanowires themselves. The effective use of redox chemistry for fusing metal nanowires into a nanostructured network is described further in U.S. Pat. No. 10,020,807 to Virkar et al. (the '807 patent), entitled “Fused Metal Nanostructured Networks, Fusing Solutions with Reducing Agents and Methods for Forming Metal Networks,” incorporated herein by reference. The '807 patent also described a single solution approach for the formation of fused metal nanostructured networks. Single solution approaches for the formation of fused metal nanostructured layers are described further in U.S. Pat. No. 9,183,968 B1 to Li et al, (hereinafter the '968 patent) entitled “Metal Nanowire Inks for the Formation of Transparent Conductive Films with Fused Networks,” incorporated herein by reference, and single solution or ink processing to form fused metal nanostructured networks is used in the Examples below.

A single ink formulation provides for depositing a desired loading of metal as a coating on the substrate surface and simultaneously providing constituents in the ink that induce the fusing process as the ink is dried under appropriate conditions. These inks can be referred to conveniently as fusing metal nanowire inks with the understanding that the fusing generally does not take place until drying. The inks generally comprise an aqueous solvent, which can further comprise an alcohol and/or other organic solvent in some embodiments. The inks can further comprise dissolved metal salts as a metal source for the fusing process. Without wanting to be limited by theory, it is believed that components of the ink, e.g., hydroxyl groups, or other organic compositions, reduce the metal ions from solution to drive the fusing process. Previous experience with the fusing process in these systems suggests that the metal preferentially deposits at the junctions between adjacent metal nanowires. A polymer binder can be provided to stabilize the coating and to influence ink properties. Polysaccharides provide hydroxyl functional groups that can function to reduce silver ions. The particular formulation of the ink can be adjusted to select ink properties suitable for a particular deposition approach and with specific coating properties on a substrate surface. As described further below, drying conditions can be selected to effectively perform the fusing process.

For a room temperature fusing process, the process conditions can be adjusted, optionally, with respect to blowing air at room temperature across the deposited coating. Slight heating can be used in some embodiments, if desired. Airflow with or without heating can speed solvent removal and corresponding concentration of the silver ions to provide for reasonable fusing rates. As long as the ion mobility is maintained and sufficiently reactive silver salts are utilized, solvent evaporation and drying (even at low temperatures) can result in fusing and excellent conductivities. Due to a hydrophilic binder generally used, water associated with the binder may dry relatively slowly. Results are presented in the Examples with sheet resistance values over a selectable range of values, and, in some embodiments, of around 35 Ohms/sq. and in another embodiment of around 3 Ohms/sq, and good transmittance values are obtained relative to achieved values of sheet resistance.

In the context of lower temperature processing, the transparent conductive inks described herein provide process advantages even relative to non-transparent alternatives. Referring to Table 1 below, the “Typical” product refers to silver nanoparticle pastes or inks that have been commercially available for some time an example is Toyobo 520H-19 or 520H-41 which cures at 130-150° C. for 30 mins. The Low Temp 1 product refers to a next generation nanoparticle based product that is processable at somewhat lower temperatures. Examples of commercially available low temperature silver pastes include PE828 (“ULTRA-LOW TEMPERATURE CURE SILVER CONDUCTOR”) from DuPont™ which can be processed from 60-100° C.

TABLE 1

| Ink Type | Optics | Drying/Curing | Substrate Types |
|---|---|---|---|
| Typical | Non- | 120-150° C./30-60 | High T_{g}/Expensive |
| | transparent | minutes | |
| Low Temp 1 | Non- | 60*-100° C./~1- | Lower T_{g} |
| | transparent | multiple hours | PVC, PC, PS, PVDF, |
| | | | PE* |
| C3 Nano | Transparent | <40° C./1-5 minutes | PET, Acrylic, PC, |
| RT Ink** | | | TPU, PE, PS, PVDF |

The ability to form room temperature conductive coatings is both a desirable processing improvement as well as an opening to achieve processing substrates that are vulnerable to heat.

### Silver Nanowire Ink and Deposition

With silver nanowire inks, the desirable processing for transparent conductive coatings has tended to favor balance (near balance of equilibria) and finesse rather than brute force, and that continues to hold true for the desirable processing approaches described herein. These results are now extended to silver nanowire inks at room temperature, but the processing is even gentler while achieving good electrical conductivity. The inks thus involve appropriate selection of the components in the right amounts. First, there are the silver nanowire, and these are discussed in detail below, and the silver nanowires may be mixed with other nanoparticulates if optical properties are less or not significant. For transparent electrically conductive coating with good optical properties, high quality silver nanowires are discussed below. The solvent is generally aqueous and can have alcohol in lower amount or large amounts. Surfactants, such as fluorosurfactants, may or may not be used, and the suitability of a surfactant may depend on the alcohol content of the solvent. Since fluorosurfactants may have environmental concerns, embodiments avoiding fluorosurfactants can be desirable from that perspective.

As a binder, polysaccharides are desirable, and in some embodiments, other polymer binders should be avoided or very limited, in the context of room temperature processing. As a fusing agent, silver fluoride is desired. In some embodiments, other components that unfavorably interact with silver ions to interfere with fusing are limited or avoided completely. Low amounts of processing additives can be tested empirically by a person of ordinary skill in the art based on the teachings herein to check whether or not they are compatible with the formation of the conductive structure.

The silver nanowire, with other nanoparticulates, can be selected as appropriate for the target application, and these can range over the spectrum from high quality very thin and uniform nanowire to mixtures of thicker nanowires with nanoparticles and other nanoparticulates. Transparent film applications generally make use of relatively pure silver nanowires. Applicant sells very high-quality silver nanowires, such as those used in the Examples below, which can be used to obtain very good optical qualities.

Marginally transparent, translucent, or opaque conductive layers can be formed from less purified dispersions of metal nanowires. Examples are presented below forming transparent or translucent coatings, but lower optical quality, electrically conductive films, that are formed with waste from synthesizing highly purified silver nanowires, in which the waste comprises ranges of nanowire morphology, nanoparticles and various other nanoparticlate shapes. This work points to the possibility of supplementing nanowires with nanoparticulates of other shapes for non-transparent applications.

Silver provides excellent electrical conductivity. The present Applicant markets silver nanowire inks for forming fused metal nanostructured networks under the tradename ActiveGrid® ink. Other silver nanowire sources are commercially available, and the basic fusing technology is well described in the '207 and '807 patents cited below. The vast majority (>98%) of silver nanowires in the Generation 5 (GEN5) ActiveGrid® product have diameters below <25 nm, and the vast majority (>98%) of silver nanowires in generation 7 (GEN7) ActiveGrid® silver nanowire diameter of <22 nm. The synthesis of thin silver nanowires is described in U.S. Pat. No. 10,714,230 B2 to Hu et al., entitled “Thin and Uniform Silver Nanowires, Methods of Synthesis and Transparent Conductive Films Formed from the Nanowires,” incorporated herein by reference. High quality silver nanowire products, with small uniform diameters and high purity, are desired for some applications for displays, but for less optically demanding applications, lower grade silver nanowires may be sufficient. Herein, nanowires are considered to have average diameters less than 100 nm and in some embodiments less than 50 nm, and average aspect ratios of at least about 10 nm, and in further embodiments at least about 25 nm. Other commercial silver nanowires are commercially available. A person of ordinary skill in the art will recognize that additional ranges of silver nanowire dimensions within the explicit ranges above are conceived and are within the present disclosure.

The solvents are aqueous. The solvents can comprise alcohol, which can improve the rheology of the inks. If alcohol is used, the selection of alcohol is not generally critical, but the alcohol generally should have a low boiling point to allow for good drying at room temperature. From this perspective, alcohols are generally monohydroxyl aliphatic alcohols with no more than 10 carbon atoms, with methanol, ethanol, propanol, isopropanol, mixtures thereof, and the like being convenient. Many alcohols form low boiling azeotropes with water, which facilitates their evaporation if in appropriate quantities. The selection of alcohols can then be influenced by the amount of alcohol. In some embodiments, the solvent comprises from 0.1 volume percent (vol %) alcohol, in further embodiments from about 0.5 vol % to about 100 vol %, and in other embodiments from about 1 vol % to about 80 vol %. If desired, the solvents can be conceptually divided into high alcohol solvents with greater than 51 vol % alcohols and low alcohol solvents with less than 50 vol % alcohols. A person of ordinary skill in the art will recognize that additional ranges of alcohol concentrations within the explicit ranges above are contemplated and are in the present disclosure. The solvent may also comprise no more than about 5 vol % of other components, such as polar solvents, for example, methyl ethyl ketone, glycol ethers (such as ethylene glycol methyl ether and propylene glycol methyl ether), methyl isobutyl ketone, toluene, hexane, ethyl acetate, butyl acetate, ethyl lactate, PGMEA (2-methoxy-1-methylethylacetate), dimethyl carbonate, or mixtures thereof. While the solvent should be selected based on the ability to form a good dispersion of metal nanowires, the solvents should also be compatible with the other selected additives so that the additives are soluble in the solvent.

For transparent applications, the desirable inks to achieve effective single inks that cure into fused nanostructured metal networks comprise a desired amount of metal nanowires to achieve appropriate loading of metal in the resulting coating. In appropriate solutions, the inks are stable prior to deposition of the ink and drying. The inks can comprise a reasonable amount of polymer binder that contributes to the formation of a stable conducting coating for further processing. To obtain good fusing results with one ink systems, hydrophilic polymers have been found to be effective as binders, in particular, such as cellulose, chitosan, xanthan gum, or other polysaccharide based polymers. As noted above, polysaccharides have demonstrated remarkable properties in the context of binders for silver nanowires. Metal ions, as a source of metal for the fusing process, can be supplied as a soluble metal salt, and AgF is suitable for room temperature processing.

A single ink formulation provides for depositing a desired loading of metal as a coating on the substrate surface and simultaneously providing constituents in the ink that induce the fusing process as the ink is dried under appropriate conditions. These inks can be referred to conveniently as fusing metal nanowire inks with the understanding that the fusing generally does not take place until some drying has occurred. The inks generally comprise an aqueous solvent, as described above, and the inks can further comprise dissolved metal salts as a metal source for the fusing process. Without wanting to be limited by theory, it is believed that components of the ink, e.g., hydroxy moieties or other organic functional groups, reduce the metal ions from solution to drive the fusing process. Previous experience with the fusing process in these systems suggests that the metal preferentially deposits at the junctions between adjacent metal nanowires. A polymer binder can be provided to stabilize the film and to influence ink properties. The particular formulation of the ink can be adjusted to select ink properties suitable for a particular deposition approach and with specific coating properties on a substrate surface. As described further below, drying conditions can be selected to effectively perform the fusing process.

The metal nanowire ink can include from about 0.01 wt % to about 3 wt % metal nanowires (nanoparticulates), in further embodiments from about 0.02 wt % to about 1.5 wt % metal nanowires (nanoparticulates) and in additional embodiments from about 0.04 wt % to about 1.0 wt % metal nanowires (nanoparticulates). While nanoparticulates are kept low for highly transparent embodiments, for less optically demanding embodiments, the inks can comprise significant amounts of other nanoparticulate shapes. In some embodiments, the nanoparticulates comprise at least about 20 wt % nanowires, in further embodiments from about 25 wt % to about 95 wt %, and in other embodiments from about 30 wt % to about 80 wt % metal nanowires. The other nanoparticlate shapes can be varied and possibly mixed, such as nanoparticles, nanocubes, nanoplates, and the like. For embodiments of particular interest, the nanowires are silver nanowires and the metal ion source is a dissolved silver salt. The ink can comprise silver ions in a concentration from about 0.01 mg/mL and about 2.0 mg/mL silver ions, in further embodiments from about 0.02 mg/mL and about 1.75 mg/mL and in other embodiments from about 0.025 mg/mL and about 1.5 mg/mL. A person of ordinary skill in the art will recognize that additional ranges of metal nanowire concentrations and metal ion concentrations within the explicit ranges above are contemplated and are within the present disclosure. The concentration of metal nanowires influences the loading of metal on the substrate surface as well as the physical properties of the ink.

Metal nanowires generally comprise silver. Applicant has formed transparent conductive films with good optical properties with noble metal coated silver nanowires. See, U.S. Pat. No. 9,530,534 to Hu et al., entitled “Transparent Conductive Film,” incorporated herein by reference. Generally, other metal nanowires would be expected to have similar properties. Gold nanowires, platinum nanowires, palladium nanowires, copper nanowires and other metal nanowires would be expected to exhibit similar performance.

With respect to the ink formulation, polymer binders and the solvents are generally selected consistently such that the polymer binder is soluble or dispersible in the solvent. In appropriate embodiments, the metal nanowire ink generally comprises from about 0.02 wt % to about 10 wt % binder, in further embodiments from about 0.05 wt % to about 8 wt % binder and in additional embodiments from about 0.1 wt % to about 5 wt % polymer binder. Suitable binder concentrations can depend on the binder molecular weights. In some embodiments, the polysaccharides can have an average molecular weight of less than 10,000 g/mol. The weight ratio of polymer binder relative to the metal nanowires/nanoparticulates can also be significant. The weight ratio of polymer binder to silver nanowires or nanoparticulates can be at least about 0.05, in some embodiments at least about 0.1, in further embodiments from about 0.2 to about 3, and in additional embodiments from about 0.3 to about 2, as well as ranges with different combinations of these lower and upper end points. A person of ordinary skill in the art will recognize that additional ranges within these explicit ranges are contemplated and are within the present disclosure. Desired binders include, for example, polysaccharides, such as cellulose based polymers, chitosan based polymers and the like. Suitable cellulose binders include, for example, ether celluloses, such as methyl cellulose, ethyl cellulose, ethyl methyl cellulose, hydroxyethyl cellulose, hydroxypropyl cellulose, hydroxyethyl methyl cellulose, hydroxypropyl methyl cellulose, carboxymethyl cellulose, mixtures thereof, and the like.

In some embodiments, the nanowire ink can optionally comprise a rheology modifying agent or combinations thereof. In particular, the ink can comprise a wetting agent or surfactant to lower the surface tension, and a wetting agent can be useful to improve coating properties. A wide range of surfactants, such as nonionic surfactants, cationic surfactant, anionic surfactants, zwitterionic surfactants, Gemini surfactants, are commercially available. Fluorosurfactants can provide desirable ink properties, but for some applications and final formulations may be undesirable. The purpose of the fluorosurfactant is to act as a wetting agent to provide lower surface tensions, good wetting and film formation on the substrate. The wetting agent generally is soluble in the solvent as used. In some embodiments, the nanowire ink can comprise from about 0.001 wt % to about 1 wt % wetting agent, in further embodiments from about 0.002 wt % to about 0.75 wt % and in other embodiments from about 0.003 wt % to about 0.6 wt % wetting agent. A person of ordinary skill in the art will recognize that additional ranges of binder, and wetting agent concentrations within the explicit ranges above are contemplated and are within the present disclosure. Effective wetting and processing can be provided by higher alcohol concentrations in the solvent, as described above. In some embodiments, with high alcohol concentrations, the presence of a separate surfactant is found to be inhibitory of room temperature processing, but in other low alcohol solvents, a separate surfactant is found to work fine. In general, other processing aids may or may not be used in various inks, such as thickeners, antioxidants, etc., and some of these may be inhibitory to the room temperature processing while others may be fine. A person of ordinary skill in the art can readily test this based on the teachings herein. Generally though, other additives would be no more than about 5 wt % of the solids, which are considered the non-volatile components.

Silver nanowires for commercial use are generally deposited by slot coating, and this can be performed in a roll-to-roll format. The coating and fusing can all be performed conveniently in this format. Applicant has generalized this processing for very thin polymer sheets with two sided conductive coatings as described in published U.S. patent application 2020/0245457 to Chen et al., entitled “Thin Flexible Structures With Surfaces With Transparent Conductive Films and Processes for Forming the Structures,” incorporated herein by reference. For non-flat surfaces, dip coating, spray coating and the like can be used. In general, the same nanowire ink formulations for slot coating can be used with these alternative coating processes, although specific embodiments may suggest modification. The conductive layers can be patterned with laser patterning or photolithography. Other similar coating processes can be used. Nanowire morphology complicates printing of nanowire inks. While crude printing of metal nanowire inks can be contemplated, printing of metal nanowire inks with good resolution for commercial production has not been accomplished to Applicant's knowledge. A description of metal nanowire printing is found in U.S. Pat. No. 8,454,859 to Lowenthal et al., entitled “Metallic Nanofiber Ink, Substantially Transparent Conductor, and Fabrication Method,” incorporated herein by reference.

The amount of silver deposited influences the optical properties and the sheet resistance. For highly transparent applications, the silver loading is generally selected to yield the desired conductivity, and the nanowire quality is important with respect to improvement of the optical properties. Loading levels of nanowires onto the substrate is generally presented as milligrams of nanowires for a square meter of substrate and can be calculated based on the deposition. For transparent applications, the nanowire networks can have a loading from about 1 mg/m² to about 500 mg/m², in further embodiments from about 0.5 mg/m² to about 200 mg/m², and in other embodiments from about 1 mg/m² to about 150 mg/m². A person of ordinary skill in the art will recognize that additional ranges of thickness and loading within the explicit ranges above are contemplated and are within the present disclosure. If the sparse metal conductive layer is patterned, the thickness and loading discussion applies only to the regions where metal is not excluded or significantly diminished by the patterning process. For non-transparent applications, the metal loading is not particularly limited, but depending on the nanoparticulate characteristics, there will be a range of translucent metal loadings and then opaque films with even higher metal loadings. Multiple coatings can be performed to increase the loading and to decrease the sheet resistance. The metal loading is effectively determined by the concentration of nanowires, or other silver particles, in the ink and the wet coating thickness.

For processing at room temperature, processing after coating the ink can be minimal. For consistency and to speed drying a little, unheated air can be gently delivered to remove the moisture. Whether or not blowing is used, sufficient drying to achieve fusing or to achieve desired conductivity without a fusing agent can be achieved in minutes. Compared with traditional coating processing times, these times are short so no effort has been devoted to pushing the time to even shorter amounts, but presumably this timing can be optimized if desired. Air knifes or the alike can also be employed to dry the solvent to provide the final conductive film. Blowing air does not seem needed to provide desirable results, but for commercial production, it may be a desirable option to help ensure consistent product quality even if not strictly needed.

While not needed for appropriate systems, some heat can be applied. If some alternative solvents are used or some additives may influence the processing, it is conceivable that some mild heat could be advantageous in some embodiments. For example, the blown air can be heated slightly, such as to temperatures noted above, or the coated substrate can be placed in an oven or the like at a sufficiently low temperature. Generally, though it is advantageous to process without added heat for cost saving and reduction of environmental footprint, as well as to open the processing to a broader range of applications. It may be useful in commercial coatings to use low temperature settings in IR, convective, or other heating systems to perform the drying.

### Electrically Conductive Structure

The electrically conductive structure can be designed to fit a particular application. Since the range of conductive coatings that can be formed using the room temperature processing described herein is large, the ranges of coatings properties can correspondingly cover wide ranges targeting different applications. Therefore, the full range of properties can be considered, and the coatings can be grouped to help focus on ranges of potential target applications. Reasonable groupings for separate consideration are selected as highly transparent (conductive layer transmittance at least about 90%), transparent (conductive layer transmittance from about 70% to about 90%), translucent (conductive layer transmittance from 0 to about 70%), and opaque (zero transmittance). These groupings are essentially arbitrary and blurred at boundaries, but these seem reasonably divided and focused according to potential applications. It should also be noted that the transparencies above relate to visible part of the electromagnetic spectrum, but this may extend into other portions of the spectrum, such as the infrared.

As noted above, the transmittance is a function of metal loading and nanowire quality, i.e., the additional particulates. To have transmittance through the conductor rather than around the conductor, the metal coating should be sparse. Nanowires have a shape that is amenable to forming conduction pathways with large gaps for the passage of light, which Applicant has termed a sparse metal layer. Due to the nanowire diameter well under the wavelength of visible light, the nanowires are not resolved by visible light so that the coating appears under visible light to be a uniform material, although with some scattering and absorption due to the plasmonic response or metallic nanostructures. Metal nanowires are used to form transparent conductive layers due to their structure, other shaped nanoparticulates generally cannot be formed into transparent conductive coatings due to the inability to form conduction pathways and holes of proper dimensions for the passage of light through the conductive structure.

As optical quality and high transmittance become less critical, blends of nanoparticulates become suitable. Thus, nanowires are not necessarily as highly purified away from other particle shapes. Nanoparticles and other odd silver particulate shapes contribute disproportionally to scattering and reflection relative to their contributions to electrical conductivity, but as optical properties become of less relevance, so do the contraindications of the presence of non-nanowire shapes. Thus, low transmittance and translucent conductive films can be formed for lower cost than high quality nanowire coatings. Once the electrically conductive coatings become opaque, presumably the coatings are no longer sparse and the nanoparticulate shapes become less relevant although nanowires still contribute disproportionally to conductivity for their weight.

The loading and proportion of silver nanowires as a fraction of the metal then influence the character of the coating following processing. For sparse metal coatings with nanowires as the dominant metal component, the average thickness is somewhat imprecise due to the gaps in the structure, but rough thickness can be described if desired, although metal loading and nanowire diameter essentially describe a sparse coating. At the other extreme, for opaque structures, the processed coating can approach more of a uniform densified material. In principle, for an opaque structure, the thickness is not limited.

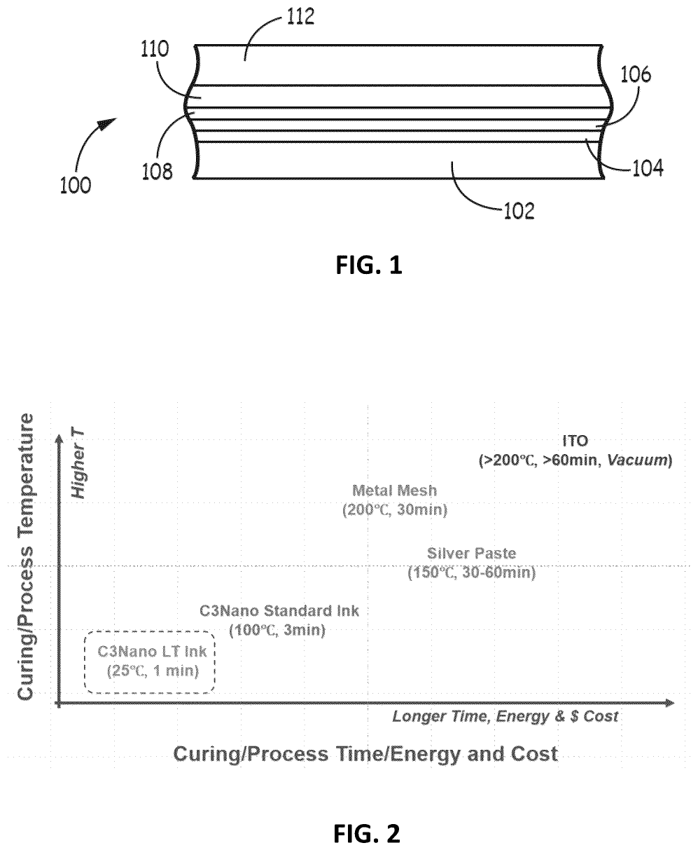

Referring to FIG. 1, representative electrically conductive film 100 comprises a substrate 102, optional undercoat layer 104, metal conductive layer 106, overcoat layer 108, adhesive layer 110 and protective surface layer 112, although not all embodiments include all layers. While polymer sheets are desirable substrates for many applications, for other substrates film 100 can be equivalently considered as an electrically conductive structure, so “film” as used herein can be equivalently considered as any reasonable structure. For transparent embodiments, metal conductive layer 106 would be sparse, substrate 102 would be transparent and adhesive layer would be optically clear, and other layers could be similarly made suitably transparent. Generally, adhesive layer 110 and protective surface layer 112 would be added after completion of significant processing described herein to improve stability of the conductive layer(s). A transparent conductive film generally comprises a sparse metal conductive layer and at least one layer on each side of the sparse metal conductive layer.

For transparent embodiments, the total thickness of a transparent conductive film can generally have an average thickness from 5 microns to about 2 millimeters (mm), in further embodiments from about 10 microns to about 1 mm and in other embodiments from about 12 microns to about 0.5 mm. A person of ordinary skill in the art will recognize that additional ranges of thicknesses within the explicit ranges above are contemplated and are within the present disclosure. In some embodiments, the length and width of the film as produced can be selected to be appropriate for a specific application so that the film can be directly introduced for further processing into a product. In additional or alternative embodiments, a width of the film can be selected for a specific application, while the length of the film can be long with the expectation that the film can be cut to a desired length for use. For example, the film can be in long sheets or a roll. Similarly, in some embodiments, the film can be on a roll or in another large standard format and elements of the film can be cut according to a desired length and width for use.

For the range of potential applications, the substrate composition can be selected from a broad range of possibilities, especially for opaque embodiments. Examples are provided on cardboard and a fresh leaf, so even some porosity can be tolerated, although clearly extreme substrates may not be suitable. As noted above, for these broader applications, the film can be considered as a structure with no significance attributed to the film terminology. Thus, glass and transparent ceramics can be suitable for transparent embodiments along with polymers, and ceramic, various organic and composite materials can be suitable substrates along with polymers for opaque embodiments. In general, multiple polymeric and biological substrates require low processing temperatures due to melting, decomposition, unwanted reactions, or other adverse transitions and effects (glass transition, softening, diffusion, color loss, modulus changes). The ability to create a conductive layer at ambient temperatures may therefore enable a host of new applications and commercial products.

Substrate 102 generally can have any reasonable dimensions. Roll-to-roll processing can be a convenient processing format for many commercial applications. Generally, for roll-to-roll embodiments, the substrate can have an average thickness from about 1 micron to about 1.5 mm, in further embodiments from about 5 microns to about 1 mm and in additional embodiments from about 10 microns to about 500 microns. In particular for foldable structures, especially double sided foldable structures, the substrate thickness can be no more than about 27 microns and in further embodiments from about 5 microns to about 25 microns. A person of ordinary skill in the art will recognize that additional ranges of thicknesses of the substrate within the explicit ranges above are contemplated and are within the present disclosure. Suitable optically clear polymers with very good transparency, low haze and good protective abilities can be used for the substrate.

Suitable polymers for a transparent substrate include, for example, polyethylene terephthalate (PET), polyethylene naphthalate (PEN), polyacrylate, poly(methyl methacrylate), polyolefin, polyvinyl chloride, fluoropolymers, polyamide, polyimide, polysulfone, polysiloxane, polyetheretherketone, polyethersulfone, polynorbornene, polyester, polystyrene, polyurethane, polyvinyl alcohol, polyvinyl acetate, acrylonitrile-butadiene-styrene copolymer, cyclic olefin polymer, cyclic olefin copolymer, polycarbonate, copolymers thereof or blend thereof or the like. Suitable commercial polycarbonate substrates include, for example, MAKROFOL SR243 1-1 CG, commercially available from Bayer Material Science; TAP® Plastic, commercially available from TAP Plastics; and LEXAN™ 8010CDE, commercially available from SABIC Innovative Plastics. Optical quality PET substrates are available from, for example, DuPont-Teijin and Toray Films (Lumirror™). Polyimide substrates are available from Kolon, and polysulfone substrates are available from Solvay. Cyclic polyolefins (COP) are available from Zeon Corporation. The lowering of process temperatures as described herein allows for the use of even greater ranges of polymers as well as other substrates. For non-transparent substrates, most materials that can be reasonably coated can be used. Protective surface layer 112 can independently have a thickness and composition covering the same thickness ranges and composition ranges as the substrate as described in this paragraph above.

If surface coating issues dominate, an undercoat can be applied. Thus, a thin polymer layer can provide a suitable surface for application of the conductive layer, although direct application of a conductive layer has been accomplished on a range of materials. Also, for many embodiments, an overcoat polymer can be desirable as a protective coating. Undercoat and/or overcoat polymers can independently include classes of polymers described above for substrates and can be applied by solution coating with optional subsequent crosslinking, such as by UV light exposure. Overcoat and undercoat polymers can be applied using the same techniques as the nanowire inks. Especially for less transparent or opaque embodiments, the thicknesses of these layers may not be significant, but for transparent embodiments and some other embodiments, the overcoat can have an average thickness from about 5 nm to about 2 microns, in further embodiments from about 7 nm to about 1 micron, and in other embodiments from about 8 nm to about 250 nm. In some embodiments, overcoats can comprise crosslinked polyacrylate, copolymers thereof or blends thereof.

Overcoats and/or undercoats can comprise stabilization compounds that can help to prolong good electrical conduction with exposure to environmental assaults. Previous work has found that vanadium (+5) compounds can be effective to provide desired stability. See published U.S. patent application 2018/0105704 to Yang et al. (hereinafter the '704 application), entitled “Stabilized Sparse Metal Conductive Films and Solutions for Delivery of Stabilizing Compounds,” incorporated herein by reference. Others have found that iron (+2) and other metal salts can be effective stabilizers, see published U.S. patent application 2015/0270024A1, to Allemand entitled “Light Stability of Nanowire-Based Transparent Conductors,” incorporated herein by reference. Also, cobalt (+2) ions complexed with ligands have been found to provide stabilization within a fused metal nanostructured network layer. The performance of these stabilization compositions alone or combined, can be enhanced through incorporation of noble metal ions, especially, silver ions within a coating (overcoat and/or undercoat) to further enhance the stability, possibly due to further fusing of the structure with migration of the metal ions. The benefits of the noble metal ions in a coating can be exploited similarly to the pentavalent vanadium during actual use of the structure in a product, although alternatively or additionally it may be beneficial to have the noble metal ions in the coating during a post deposition heat/humidity processing prior to assembly into a final product.

Suitable vanadium +5 compounds include compounds with the vanadium as a cation as well as compounds with vanadium as a part of a multi-atom anion, such as metavanadate (VO₃⁻) or orthovanadate (VO₄⁻³). Corresponding salt compounds with pentavalent vanadium anions in an oxometalate include, for example, ammonium metavanadate (NH₄VO₃), potassium metavanadate (KVO₃), tetrabutylammonium vanadate (NBu₄VO₃), sodium metavanadate (NaVO₃), sodium orthovanadate (Na₃VO₄), other metal salts and the like, or mixtures thereof. Suitable penta-valent vanadium cation compounds include, for example, vanadium oxytrialkoxides (VO(OR)₃, R is an alkyl group, for example, n-propyl, isopropyl, ethyl, n-butyl, or the like, or combinations thereof), vanadium oxytrihalides (VOX₃ where X is Cl, F, Br or combinations thereof), vanadium complexes, such as VO₂Z₁Z₂, where Z₁ and Z₂ are independently ligands such as those described further below with respect to Co+2 complexes, or combinations thereof. In coatings, the penta-valent vanadium can be present, for example, from about 0.01 wt % to about 9 wt %, in further embodiments, from about 0.02 wt % to about 8 wt % and in additional embodiments from about 0.05 wt % to about 7.5 wt %. In a coating solution, the solution generally comprises some solvent along with the solids that primarily comprise a curable polymer. Generally, the corresponding coating solution can have the penta-valent vanadium compounds in concentrations from about 0.0001 wt % to about 1 wt %. A person of ordinary skill in the art will recognize that additional ranges of concentrations within the explicit ranges above are contemplated and are within the present disclosure. In additional or alternative embodiments, iron (+2) or other metal ions can be included in addition to or alternatively to the pentavalent vanadium ions.

Furthermore, noble metal ions, and in particular silver ions, can also be included in the solution for forming the coating. As used herein noble metal ions refer to ions of silver, gold, platinum, indium, osmium, ruthenium, and rhodium. The noble metal ions can be added as a suitable salt, such as nitrate, sulfate, perchlorate, tetrafluoroborate, hexafluorophosphate, hexafluoroantimonate, and halides. Suitable metal salts for providing the metal ions include, for example, chloroauric acid, palladium chloride. For silver salts, if the coating polymer is deposited with an alcohol or other non-aqueous organic solvent, suitable silver salts and complexes to obtain sufficient solubility include, for example, silver tetrafluoroborate (AgBF₄), silver hexafluorophosphate (AgPF₆), silver perchlorate (AgClO₄), silver hexafluoroantimonate (AgSbF₆), silver trifluoroacetate (AgCF₃COO), silver heptafluorobutyrate (AgC₄F₇O₂), silver methylsulfonate (AgCH₃SO₃), silver tolylsulfonate (AgCH₃C₆H₄SO₃), or mixtures thereof. In coatings, the noble metal ions can be present, for example, from about 0.01 wt % to about 20 wt %, in further embodiments, from about 0.05 wt % to about 15 wt %, in other embodiments from about 0.1 wt % to about 12 wt %, in some embodiments from about 0.2 wt % to about 9 weight percent, and in additional embodiments from about 0.25 wt % to about 7.5 wt %. In a coating solution, the solution generally comprises some solvent along with the solids that primarily comprise a curable polymer. A person of ordinary skill in the art will recognize that additional ranges of concentrations within the explicit ranges above are contemplated and are within the present disclosure.

For use directly in a transparent conductive layer, especially with fused metal nanostructured networks, cobalt with a +2 valence has been found to be effective for stabilization without interfering with the fusing process. Suitable cobalt compounds include, for example, Co(NO₃)₂ with various complexing ligands, such as nitrite (NO₂⁻), diethyl amine, ethylene diamine (en), nitrilotriacetic acid, iminobis(methylene phosphonic acid), aminotris(methylene phosphonic acid), ethylene diamine tetraacetic acid (EDTA), 1,3-propylenediaminetetraacetic acid (1,3-PDTA), triethylene tetramine, tri(2-aminoethyl)amine, 1,10-phenanthroline, 1,10-phenanthroline-5,6-dione, 2,2′-bipyridine, 2,2′-bipyridine-4,4′-dicarboxylic acid, dimethylglyoxime, salicylaldoxime, diethylenetriaminepentaacetic acid, 1,2-cyclohexanediaminotetraacetic acid, iminodiacetic acid, methyliminodiacetic acid, N-(2-acetamide) iminoacetic acid, N-(2-carboxyethyl) iminodiacetic acid, N-(2-carboxymethyl)imino dipropionic acid, picolinic acid, dipicolinic acid, histidine, combinations thereof. Cobalt ions have been previously suggested as a suitable ion source for fusing metal at nanowire junctions in the '807 patent cited above. As shown in the '704 application, Co+2 actually destabilizes the transparent conductive film unless it is complexed with a ligand. With respect to the use of cobalt +2 stabilization compounds in the layer with the fused metal nanostructured network, the stabilization compounds would be added with a silver salt or other salt of a cation that would be much more readily reduced so that the cobalt +2 cations remain in the material following the fusing process. On the other hand, a stoichiometric amount of ligands for Co+2 has been found to interfere with the fusing process to form a fused nanostructured network. In the layer with the fused metal nanostructured network, the concentration of the cobalt +2 stabilization compounds can be from about 0.1 wt % to about 10 wt %, in further embodiments, from about 0.02 wt % to about 8 wt % and in additional embodiments from about 0.025 wt % to about 7.5 wt %. For the cobalt compositions to be effective without interfering with the fusing process, complexing ligands can be present in amounts from about 0.1 to about 2.6 ligand binding equivalents per mole cobalt, in further embodiments from about 0.5 to about 2.5 and in other embodiment from about 0.75 to about 2.4 ligand binding equivalents per mole cobalt With respect to equivalents, this terminology is intended to indicate that ligands that are multidentate have correspondingly molar ratios for the above ranges divided by their coordination number. With respect to the ink used to deposit the metal nanowires, the solution can comprise the cobalt +2 compounds in concentrations from about 0.0001 wt % to about 1 wt %, although further details of the nanowire inks are presented below. A person of ordinary skill in the art will recognize that additional ranges of concentrations within the explicit ranges above are contemplated and are within the present disclosure.

### Coating Properties

The electrically conductive coatings can be formed for transparent or non-transparent layers. In appropriate embodiments, transparent conductive layers, such as those with a fused metal nanostructured network, can provide low electrical resistance while providing good optical properties. Thus, the structures can be useful as transparent conductive electrodes or the like. The transparent conductive electrodes can be suitable for a range of applications such as electrodes along light receiving surfaces of solar cells. For displays and in particular for touch screens, the films can be patterned to provide electrically conductive patterns formed by the structure. The substrate with the patterned structure, generally has good optical properties at the respective portions of the pattern. Non-transparent, such as translucent or opaque, layers are generally formed with higher metal loading to impart lower sheet resistances. For these coatings, generally haze and other optical properties are not of particular concern.

Electrical resistance of thin coatings can be expressed as a sheet resistance, which is reported in units of ohms per square (Q/Q or ohms/sq) to distinguish the values from bulk electrical resistance values according to parameters related to the measurement process. Sheet resistance along a surface can be generally measured using a four point probe measurement or another suitable process. In some embodiments, the fused metal nanowire networks can have a sheet resistance of no more than about 1000 ohms/sq, in some embodiments no more than about 500 ohms/sq, in further embodiments no more than about 200 ohms/sq, in additional embodiments no more than about 100 ohms/sq, in other embodiments no more than about 80 ohms/sq., and in some embodiments no more than about 50 Ohms/sq. For transparent films with a transmittance of visible light down to about 70%, sheet resistance values have been achieved down to about 3 Ohms/sq., and some optimization can likely push this slightly lower. For non-transparent coatings, sheet resistance values below 1 Ohm/sq can be achieved and translucent coatings can be formed roughly in the range between these values. While not being limited by theory, it is believed that arbitrarily low resistances can be achieved by simply increasing the silver loading and/or by coating thicker. A person of ordinary skill in the art will understand this system can be modelled well using a parallel resistor model wherein the resistance can be estimated by the thickness. For example, if the conductive coating thickness is increased 2 fold from the thickness which achieved 1 ohm/sq, the thicker (2 fold) film should have a resistance of 0.5 ohms/sq. A person of ordinary skill in the art will recognize that additional ranges of sheet resistance within the explicit ranges above are contemplated and are within the present disclosure.

Depending on the particular application, commercial specifications for sheet resistances for use in a device as a transparent conductive film may not be necessarily directed to lower values of sheet resistance such as when additional cost may be involved, and current commercially relevant values may be for example, 250 ohms/sq, versus 150 ohms/sq, versus 100 ohms/sq, versus 50 ohms/sq, versus 40 ohms/sq, versus 30 ohms/sq, versus 20 ohms/sq or less as target values for different quality and/or size touch screens, and each of these values defines a range between the specific values as end points of the range, such as 150 ohms/sq to 20 ohms/sq and the like. Thus, lower cost coatings may be suitable for certain applications in exchange for modestly higher sheet resistance values. In general, sheet resistance can be reduced by increasing the loading of nanowires, but an increased loading may not be desirable from other perspectives, and metal loading is only one factor among many for achieving low values of sheet resistance.

Transparent conductive layers are generally formed with attention to other optical properties. On the other hand, translucent and opaque conductive layers are generally formed without particular concern over the optical properties, although some attention to the optical properties can be exploited based on the teachings herein. The immediately following discussion is directed to optical properties of transparent coatings.

For applications as transparent conductive films, it is desirable for the fused metal nanowire networks or other sparse metal conductive layers to maintain good optical transparency. In principle, optical transparency is inversely related to the loading with higher loadings leading to a reduction in transparency, although processing of the network can also significantly affect the transparency. Also, polymer binders and other additives can be selected to maintain good optical transparency. The optical transparency can be evaluated relative to the transmitted light through the substrate. For example, the transparency of the conductive film described herein can be measured by using a UV-Visible spectrophotometer and measuring the total transmission through the conductive film and support substrate. Transmittance is the ratio of the transmitted light intensity (I) to the incident light intensity (Iₒ). The transmittance through the coating (T_{coating}) can be estimated by dividing the total transmittance (T) measured by the transmittance through the support substrate (T_{sub}). (T=I/Iₒ and T/T_{sub}=(I/Iₒ)/(I_{sub}/Iₒ)=I/I_{sub}=T_{coating}). Thus, the reported total transmissions can be corrected to remove the transmission through the substrate to obtain transmissions of the coating alone. While it is generally desirable to have good optical transparency across the visible spectrum, for convenience, optical transmission can be reported at 550 nm wavelength of light. Alternatively or additionally, transmission can be reported as total transmittance from 400 nm to 700 nm wavelength of light, and such results are reported in the Examples below. In general, for the fused metal nanowire films, the measurements of 550 nm transmittance and total transmittance from 400 nm to 700 nm (or just “total transmittance” for convenience) are not qualitatively different. In some embodiments, the coating formed by the fused network has a total transmittance (TT %) of at least 70%, in embodiments at least about 80%, in further embodiments at least about 85%, in additional embodiments, at least about 90%, in other embodiments at least about 94%, in further embodiments at least about 95 and in some embodiments from about 96% to about 99.5%. Transparency of the films on a transparent polymer substrate can be evaluated using the standard ASTM D1003 (“Standard Test Method for Haze and Luminous Transmittance of Transparent Plastics”), incorporated herein by reference. The TT % through the entire structure includes lowering of transmittance due to the substrate and overcoats, and can shift the lower ends of the above ranges of transmittance from 1% to 10% and in some embodiments by 2.5% to 5%. A person or ordinary skill in the art will recognize that additional ranges of transmittance within the explicit ranges above are contemplated and are within the present disclosure. When adjusting the measured optical properties for the coatings in the Examples below for the substrate, the coatings have very good transmission and haze values, which are achieved along with the low sheet resistances observed.

The fused metal networks can also have low haze along with high transmission of visible light while having desirably low sheet resistance. Haze can be measured using a hazemeter based on ASTM D1003 referenced above, and the haze contribution of the substrate can be removed to provide haze values of the transparent conductive film. In some embodiments, the transparent coating can have a haze value of no more than about 1.2%, in further embodiments no more than about 1.1%, in additional embodiments no more than about 1.0% and in other embodiments as low as 0.1%. As described in the Examples, with appropriately selected silver nanowires very low values of haze and sheet resistance have been simultaneously achieved. The loading can be adjusted to balance the sheet resistance and the haze values with very low haze values possible with still good sheet resistance values. Specifically, haze values of no more than 0.8%, and in further embodiments from about 0.4% to about 0.7%, can be achieved with values of sheet resistance of at least about 45 ohms/sq. Also, haze values of 0.7% to about 1.2%, and in some embodiments from about 0.75% to about 1.05%, can be achieved with sheet resistance values of from about 30 ohms/sq to about 45 ohms/sq. All of these coatings maintained good optical transparency. A person of ordinary skill in the art will recognize that additional ranges of haze within the explicit ranges above are contemplated and are within the present disclosure.

### EXAMPLES

### General Materials and Methods

Inks S1-S7 were prepared based on ActiveGrid® Inks from Applicant C3Nano, Inc. as shown in Table 2. The ActiveGrid® Inks include GEN5 ActiveGrid® Ink with silver nanowires <25 nm in average diameter, GEN7 ActiveGrid® Ink with silver nanowires about 18 nm in average diameter, and GEN8 ActiveGrid® Ink with silver nanowires of average diameter of 13-15 nm. The inks included a hydroxyalkyl alkyl cellulose binder. Some of the ink formulations included silver salt AgOAc or AgF, and different levels of each silver salt were employed as detailed below for each example. The standard levels (1×) of AgF in GEN7 (1×_{G7}) and GEN8 (1×_{G8}) inks are about 50% greater than that of GEN5 inks. The silver salts were used in inks for the examples and are referred to as NanoGlue® AgOAc and NanoGlue® HF.

TABLE 2

| | | NanoGlue ® |
|---|---|---|
| Ink | AgNW | Fusing Agent |
| S1 | GEN5 | AgOAc |
| S2 | GEN5 | HF |
| S3 | GEN7 | AgOAc |
| S4 | GEN7 | HF |
| S5 | GEN8 | HF |
| S6 | GEN5 | none |
| S7 | GEN7 | none |

The inks were coated on various polymer substrates as shown in Table 3. Substrates included 50 μm PET (polyethylene terephthalate) with and without a hard coat layer, and COP (cyclic olefin polymer). The inks were coated with a slot coater set at different gap thicknesses of 1.5 mil (38.1 μm) or 4.0 mil (101.6 μm). For some samples, the inks were coated with a wire wound rod #14 to provide a gap thickness of 1.4 mil (35.6 μm).

TABLE 3

| | Average | Average |
|---|---|---|
| Substrate | % TT | % H |
| 50 μm PU | 94.0 | 0.87 |
| 50 μm primed PET | 93.6 | 0.58 |
| 50 μm hardcoated PET | 93.7 | 0.53 |
| 50 μm COP | 93.6 | 0.07 |

The samples were subjected to various processing conditions as detailed below for each example. Some of the wet coatings were initially dried with an air gun (with room temperature 25° C. air) approximately 1.5-3 inches above the film for about 30-60 seconds, and some were further heated in an oven heated at different temperatures ranging from 35° C. to 120° C. and different times ranging from 0.5 minutes to 210 minutes. Some of the wet coatings were dried at room temperature without any heating. Some of the wet coatings were dried at room temperature conditions with a fan blowing cool air at about 21° C. over the samples.

Average sheet resistance was measured using a sheet resistance measurement device from SURAGUS GmbH. Average percent total transmission (% TT) and average percent haze (% H) were measured using a haze meter. Average b* was measured using a colorimeter.

In general, processing to form the transparent conductive film was essentially as described in Example 5 of the '968 patent, cited above, with silver nanowires synthesized as described in U.S. Pat. No. 10,714,230B2 to Hu et al., entitled “Thin and Uniform Silver Nanowires, Methods of Synthesis and Transparent Conductive Films Formed From the Nanowires,” incorporated herein by reference.

### Example 1—Processing with or without Heat with Different Fusing Agents

This example demonstrates the performance of silver nanowire films with different silver salts dried and/or processed under different conditions as described below in Tables 4 and 5. Coatings were prepared on primed PET with 1.5 mil gap thickness.

TABLE 4

| | | Oven | Oven | Average Sheet |
|---|---|---|---|---|
| Ink S1 | Drying | Temperature | Time | Resistance |
| Sample No. | Conditions | (° C.) | (min) | (Ohms/sq) |
| 1 | heat gun | — | — | 57 |
| 2 | heat gun | 120 | 2 | 37 |
| 3 | heat gun | 50 | 2 | 49 |
| 4 | heat gun | 50 | 5 | 47 |
| 5 | heat gun | 50 | 20 | 49 |
| 6 | heat gun | 50 | 60 | 45 |
| 7 | heat gun | 50 | 90 | 43 |
| 8 | heat gun | 50 | 120 | 42 |
| 9 | heat gun | 50 | 210 | 43 |
| 10 | no heating or | — | — | 64 |
| | oven drying | | | |

TABLE 5

| | | Oven | Oven | Average Sheet |
|---|---|---|---|---|
| Ink S2 | Drying | Temperature | Time | Resistance |
| Sample No. | Conditions | (° C.) | (min) | (Ohms/sq) |
| 1 | heat gun | 120 | 2 | 35 |
| 2 | heat gun | 50 | 2 | 35 |
| 3 | heat gun | 50 | 2 | 33 |
| 4 | heat gun | 50 | 1 | 33 |
| 5 | heat gun | 50 | 0.5 | 33 |
| 6 | heat gun | 40 | 2 | 34 |
| 7 | heat gun | 40 | 1 | 33 |
| 8 | heat gun | 35 | 1 | 33 |
| 9 | heat gun | — | — | 32 |
| 12 | no heating or | — | — | 32 |
| | oven drying | | | |
| 11 | no heating or | — | — | 31 |
| | oven drying | | | |

As shown in Table 4, sample 2 dried in the oven at 120° C. for 2 minutes exhibited the lowest sheet resistance of 37 Ohms/sq. Samples 3-5, dried in the oven at 50° C. for 90 to 210 minutes, exhibited similar sheet resistances of 42-43 Ohms/sq such that the sheet resistance did not significantly decrease after 90 minutes, at least up to 210 minutes. Sample 6, dried in the oven at 50° C. for 60 minutes, exhibited a sheet resistance of 45 Ohms/sq. Thus, for samples 3-9 dried at 50° C., sheet resistance decreased as drying time increased, with sheet resistance approaching the lowest value obtained for sample 2 dried at 120° C. Even after 210 minutes, samples dried at 50° C. presumably did not fuse to the same extent as sample 2 dried at 120° C. Samples 1 and 10, dried without heating in the oven, exhibited the highest sheet resistances as compared to samples that were dried using heat. Sample 1 dried with the heat gun and not placed in the oven had a sheet resistance of 57 Ohms/sq and the sample that was not dried with the heat gun or placed in the oven had a sheet resistance of 64 Ohms/sq.

As shown in Table 5, samples 9-11 were not dried in the oven and exhibited the lowest sheet resistances of 31-32 Ohms/sq. Sample 9 was dried using only the heat gun, and Samples 10 and 11 were dried without heat. Samples 2-5, dried at 50° C. from 0.5 to 2 minutes, exhibited similar sheet resistances of 33-35 Ohms/sq, with samples 2 and 3 being repeat samples. Samples 6-8, dried at 35-40° C. for 1 to 2 minutes, exhibited about the same sheet resistances regardless of temperature or time, and which were similar to sheet resistances obtained at 50° C. Sample 1, dried with the heat gun and in the oven at 120° C., exhibited a sheet resistance of 35 Ohms/sq which may be comparable or higher than that exhibited by samples 2 and 3 dried at 50° C.

The data shown in Tables 4 and 5 exemplify differences in sheet resistances obtained with AgF versus AgOAc as fusing agents. Sheet resistances for S2 fused with AgF were approximately independent of processing conditions, which was not the case for S1 fused with AgOAc. Sheet resistances for S2 were approximately the same regardless of temperatures ranging from room temperature to 120° C., at least over the times ranging between 1 and 2 minutes, however, the data suggest that processing without heat provides a more desirable result regarding sheet resistance, as compared to drying at temperatures as low as 35° C. Processing conditions of samples including AgF provide a more desirable result regarding sheet resistance, as compared to drying under any of the conditions investigated when AgOAc was used.

### Example 2—Processing with AgOAc with or without Heat

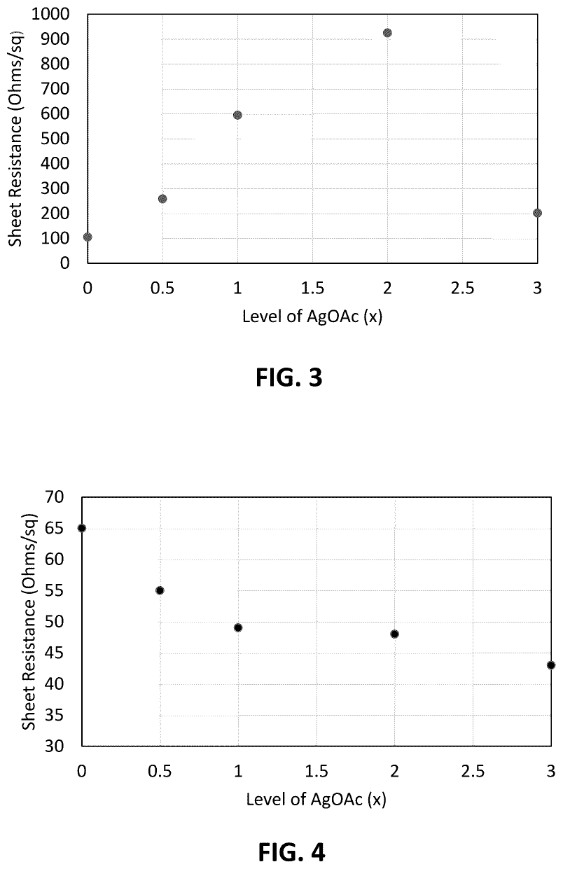

This example demonstrates the performance of silver nanowire films with AgOAc used at different levels in the ink. Coatings with S1 inks were prepared with 1.5 mil gap thickness coated on double sided HC-PET. The data shown in Table 6 are for samples dried with cool air from a fan and are plotted in FIG. 3. The data shown in Table 7 are for samples dried at room temperature, then heated for 2 minutes at 120° C. and are plotted in FIG. 4. Differences in the data shown in Tables 6 and 7 are shown in Table 8.

TABLE 6

| | Average | | | |
|---|---|---|---|---|
| Ink S1 | Sheet | Average | | |
| AgOAc | Resistance | % TT | Average | Average |
| Level¹ | (Ohms/sq) | (% TT TCF) | % H | b* |
| 0x | 105 | 91.9 (98.1) | 0.91 | 0.84 |
| 0.25x | 258 | 91.8 (98.0) | 0.94 | 0.92 |
| 0.5x | 594 | 91.9 (98.1) | 0.93 | 0.92 |
| 1x | 924 | 91.8 (98.0) | 0.93 | 0.91 |
| 1.5x | 201 | 91.9 (98.1) | 0.96 | 0.95 |

¹Relative amounts with respect to a reference quantity and multiples or fractions thereof. GEN5 ink was used.

TABLE 7

| | Average | | | |
|---|---|---|---|---|
| Ink S1 | Sheet | Average | | |
| AgOAc | Resistance | % TT | Average | Average |
| Level | (Ohms/sq) | (% TT TCF) | % H | b* |
| 0x | 65 | 91.8 (98.0) | 0.93 | 0.89 |
| 0.25x | 55 | 91.9 (98.1) | 0.97 | 0.98 |
| 0.5x | 49 | 91.8 (98.0) | 0.96 | 0.94 |
| 1x | 48 | 91.8 (98.0) | 0.95 | 0.90 |
| 1.5x | 43 | 91.6 (97.8) | 1.07 | 1.80 |

TABLE 8

| Ink S1 | ΔSheet | | |
|---|---|---|---|
| AgOAc | Resistance | | |
| Level | (Ohms/sq) | Δ% H | Δb* |
| 0x | −40 | +0.02 | +0.05 |
| 0.25x | −203 | +0.03 | +0.06 |
| 0.5x | −345 | +0.03 | +0.02 |
| 1x | −876 | +0.02 | −0.01 |
| 1.5x | −158 | +0.11 | +0.85 |

The data in Table 6 (cool air) show that sheet resistance increases up to a 1× level for AgOAc, but then drops at 1.5× to a level comparable to that of 0×. The data in Table 7 (heated at 120° C.) show that sheet resistance decreases as a function of increasing AgOAc. For AgOAc present in the ink at a 1.5× level, the resulting sheet resistance is different depending on whether the samples were processed with cool air versus heating at 120° C. The differences in properties from the room temperature processed values in Table 6 and the heat treated samples in Table 7 are presented in Table 8. As shown in Table 8, the sheet resistance of a sample with 1.5×AgOAc and processed with cool air is less by 158 Ohms/sq compared to that of a sample processed with heating at 120° C. Table 8 also shows that the sheet resistance of a sample without AgOAc and processed with cool air is greater by 40 Ohms/sq compared to that of sample processed with heating at 120° C. The behavior in Table 6 is somewhat surprising since the sheet resistance increases significant just by the addition of silver acetate salt. One plausible explanation is that silver acetate as a polar salt interferes with the interaction of the cellulose binder with the silver nanowires, or modifies the microscopic structure of the film as it is formed. Applicant has previously observed that the current system involving the cellulose is very effective at inducing good interactions between unfused silver nanowires as compared with other organic binders, so if this favorable microscopic structure is disturbed, high values of sheet resistance could be observed. Some cellulose has the potential to enhance silver nanowire contact when forming the conductive film. At least with aqueous and alcoholic systems this has been the case. On the other hand, a change in solvent system may still lead to very different results.

For % H, the data in Table 6 show that values are about that same for 0.25× to 1×, but perhaps % H increases at the 1.5× level. While the 1.5× Nanoglue® levels are useful for additional lowering of the sheet resistance, some degradation of optical properties is observed. The data in Table 7 show the same trend, with a larger increase in % H at the 1.5× level. For % TT, the data in Tables 6 and 7 show that values hold constant regardless of processing conditions. For b*, the data in Table 6 show that values are about that same for 0.25× to 1.5× with an increase of about 0.1% compared to the 0× sample. The data in Table 7 show less of an increase for the 0.25× to 1× when heated versus cool air, however, b* doubles from 1× to 1.5× levels.

### Example 3—Processing with HF, with or without Heat

This example demonstrates the performance of a silver nanowire ink with HF at a 1× level with GEN5 ink when coated at different thicknesses and subjected to different processing conditions.

Ink S2 with HF at a 1× level was coated at 1.5 mil or 4.0 mil gap thicknesses on COP, and samples for each of the thicknesses were processed as described in Table 9. Since the ink concentrations are unchanged, the larger gap thickness results in a proportionally larger metal loading. An S2 ink with a higher level of Ag (labelled Ag-1×) but the same 1× level of AgF was also prepared and coated at 4.0 mil thickness and processed with cool air. Results are shown in Table 9. Transmittance in Table 9 is reported for both the overall structure and parenthetically for just the transparent conductive film (TCF).

TABLE 9

| S2 | Blade | | Average Sheet | Average | |
|---|---|---|---|---|---|
| HF | Thickness | Processing | Resistance | % TT | Average |
| Level | (mil) | Conditions | (Ohms/sq) | (% TT TCF) | % H |
| 1x | 1.5 | cool fan | 36 | 91.9 (98.2) | 0.79 |
| 1x | 1.5 | 2 min at | 37 | 92.0 (98.3) | 0.94 |
| | | 120° C. | | | |
| 1x | 4.0 | cool fan | 10 | 88.2 (94.2) | 2.35 |
| 1x | 4.0 | 2 min at | 11 | 88.7 (94.8) | 2.70 |
| | | 120° C. | | | |
| Ag-1x | 4.0 | cool fan | 6 | 85.1 (90.9) | 3.45 |

For samples prepared from ink S2 with a 1× level of HF, the data in Table 9 show that for either thickness, little or no change in surface resistance or % TT is exhibited with differences in processing conditions. The samples coated at the 4.0 mil thickness exhibited lower sheet resistance by about 26 Ohms/sq and a decrease in % TT of about 3-4%, as compared to the samples coated at 1.5 mil. Evidence then suggests roughly full fusing at room temperature (cool fan).

Values for % H increase by about 0.1% at the 1.5 mil thickness, and by about 0.35% at the 4.0 mil thickness, depending on processing conditions. At 1.5 mil thickness, both samples exhibited % H of 0.8-0.9. At 4.0 mil thickness, effects of processing conditions were more pronounced with the sample processed with cool air exhibiting % H of 2.35%, and the sample processed for 2 min at 120° C. exhibiting % H of 2.70%.

### Example 4—Processing of Inks with Smaller Diameter Silver Nanowires, with HF

This example demonstrates the performance of a silver nanowire ink including silver nanowires having smaller diameters than those included in the S3 inks of Example 3. GEN7 ActiveGrid™ Ink, with HF at a 1×_{G7} level was coated at different thicknesses and subjected to different processing conditions, although the base amount (1×) is somewhat higher concentration for the thinner nanowires.

Ink S4 with HF at a 1× level were coated at 1.5 mil or 4.0 mil gap thicknesses on COP, and samples for each of the thicknesses were processed as described in Table 10. An S4 ink with a higher level of Ag (labelled Ag-1×) and the same 1× level of AgF was also prepared and coated at 4.0 mil thickness and processed with cool air. Results are shown in Table 10. Transmittance in Table 10 is reported for both the overall structure and parenthetically for just the transparent conductive film (TCF).

TABLE 10

| S4 | Blade | | Average Sheet | Average | |
|---|---|---|---|---|---|
| HF | Thickness | Processing | Resistance | % TT | Average |
| Level | (mil) | Conditions | (Ohms/sq) | (% TT TCF) | % H |
| 1x | 1.5 | cool fan | 32 | 92.1 (98.4) | 0.62 |
| 1x | 1.5 | 2 min at | 34 | 91.9 (98.2) | 0.76 |
| | | 120° C. | | | |
| 1x | 4.0 | cool fan | 9 | 89.1 (95.2) | 1.76 |
| 1x | 4.0 | 2 min at | 11 | 87.9 (93.9) | 2.13 |
| | | 120° C. | | | |
| Ag-1x | 4.0 | cool fan | 3 | 78.6 (84.0) | 4.78 |

For samples prepared from ink S4 with a 1× level of HF, the data in Table 10 show that for either thickness, little or no change in surface resistance or % TT is exhibited with differences in processing conditions. The samples coated at the 4.0 mil thickness exhibited lower sheet resistance by about 23 Ohms/sq and a decrease in % TT of about 3-4%, as compared to the samples coated at 1.5 mil. The data with respect to sheet resistance and % TT are comparable to that obtained for S2 inks prepared with GEN5 inks, although sheet resistance is somewhat less. Again, these results indicate that roughly full fusing seems to occur without application of any heat (cool fan). These results indicate that a transparent coating (>70% TT) can be formed at a 3 Ohm/sq. sheet resistance.

Values for % H increase by about 0.1% at the 1.5 mil thickness, and by about 0.37% at the 4.0 mil thickness, depending on processing conditions. At 1.5 mil thickness, both samples exhibited % H of 0.6-0.8%. At 4.0 mil thickness, effects of processing conditions were more pronounced with the sample processed with cool air exhibiting % H of 1.76%, and the sample processed for 2 min at 120° C. exhibiting % H of 2.13%.

### Example 5—Comparison of Inks with Different Diameter Silver Nanowires, with HF

Differences in the data shown in Tables 9 and 10 are shown in Table 11.

TABLE 11

| Inks | Blade | | ΔSheet | | |
|---|---|---|---|---|---|
| S2 and S4 | Thickness | Processing | Resistance | | |
| HF Level | (mil) | Conditions | (Ohms/sq) | Δ% TT | Δ% H |
| S2-1x | 1.5 | cool fan | | | |
| S4-1x | 1.5 | cool fan | −4 | +0.2 | −0.17 |
| S2-1x | 1.5 | 2 min, 120° C. | | | |
| S4-1x | 1.5 | 2 min, 120° C. | −3 | −0.1 | −0.18 |
| S2-1x | 4.0 | cool fan | | | |
| S4-1x | 4.0 | cool fan | −1 | +0.9 | −0.59 |
| S2-1x | 4.0 | 2 min, 120° C. | | | |
| S4-1x | 4.0 | 2 min, 120° C. | 0 | −0.8 | −57 |
| S2-Ag-1x | 4.0 | cool fan | | | |
| S4-Ag-1x | 4.0 | cool fan | −3 | −6.5 | +1.33 |

The data shown in Table 11 show that the S4 inks generally exhibit a lower average sheet resistance as compared to the S3 inks. The % TT ranges from about 92% to about 85% for all coatings, except for the S4 ink prepared with Ag-1× which exhibited a % TT of about 79%. The % H was generally less for the S4 inks as compared to the S2 inks, except for the S4 ink prepared with Ag-1× which exhibited an increase of about 1.3%.

### Example 6—Processing with Cool Air for Inks with AgF

This example explores performance of ink coatings on different polymer substrates, when the inks are processed by drying with cool air for about 1 to 5 minutes. The inks are formulated with silver nanowires of different diameters, and the coatings have different thicknesses. Variations in coatings and performance data are summarized in Table 12. Transmittance in Table 12 is reported for both the overall structure and parenthetically for just the transparent conductive film (TCF).

TABLE 12

| | | | Average | ΔSheet | Avg. | | |
|---|---|---|---|---|---|---|---|
| | | Blade | Sheet | Resistance | % TT | | |
| | | Thickness | Resistance | (Ohms/ | (% TT | Avg. % | |
| Ink | Substrate | (mil) | (Ohms/sq) | sq) | TCF) | H | Δ % H |
| S2 | primed PET | 1.5 | 40 | | 91.9 (98.2) | 1.22 | |
| S4 | primed PET | 1.5 | 33 | −7 | 92.0 (98.3) | 1.00 | −0.22 |
| S2 | hardcoated PET | 1.5 | 35 | | 91.8 (98.0) | 1.31 | |
| S4 | hardcoated PET | 1.5 | 29 | −6 | 91.9 (98.1) | 1.01 | −0.31 |
| S2 | COP | 1.5 | 36 | | 91.9 (98.2) | 0.79 | |
| S4 | COP | 1.5 | 32 | −4 | 92.1 (98.4) | 0.62 | −0.17 |
| S2 | COP | 4.0 | 10 | | 88.2 (94.2) | 2.35 | |
| S4 | COP | 4.0 | 9 | −1 | 89.1 (95.2) | 1.76 | −0.59 |
| S5 | COP | 4.0 | 15 | | 89.2 (95.3) | 1.17 | |

The data shown in Table 12 suggest that coatings prepared from S4 inks generally exhibited a lower average sheet resistance as compared to the S2 inks. The % TT ranges from about 89% to about 92% for all coatings. The % H was generally less for the S4 inks as compared to the S2 inks. The coatings prepared with 4.0 mil gap thickness exhibited lower sheet resistance than the corresponding 1.5 mil coatings, % TT slightly lower for the thicker coatings and % H slight greater for the thicker coatings. Overall, there was little to no difference between the primed PET, hardcoated PET and COP.

### Example 7—Processing with Cool Air for Inks with and without AgF

This example further explores performance of ink coatings with and without AgF as fusing agent. Inks were formulated with silver nanowires of different average diameters and each was coated on COP and PU. All samples were processed by drying with cool air. Variations in coatings and performance data are summarized in Table 13. Transmittance in Table 13 is reported for both the overall structure and parenthetically for just the transparent conductive film (TCF).

TABLE 13

| | | | Average | ΔSheet | Avg. | | |
|---|---|---|---|---|---|---|---|
| | | Blade | Sheet | Resistance | % TT | | |
| | | Thickness | Resistance | (Ohms/ | (% TT | Avg. % | |
| Ink | Substrate | (mil) | (Ohms/sq) | sq) | TCF) | H | Δ % H¹ |
| S6 | COP | 1.5 | 69 | | 92.4 (98.7) | 0.75 | |
| S2 | COP | 1.5 | 36 | −33 | 91.9 (98.2) | 0.79 | +0.04 |
| S7 | COP | 1.5 | 77 | | 92.6 (98.9) | 0.58 | |
| S4 | COP | 1.5 | 32 | −45 | 92.1 (98.4) | 0.62 | +0.04 |
| S6 | PU | 1.4 | 107 | | 92.5 (98.4) | 1.68 | |
| S2 | PU | 1.4 | 38 | −69 | 92.0 (97.9) | 1.76 | +0.12 |
| S7 | PU | 1.4 | 127 | | 92.7 (98.6) | 1.42 | |
| S4 | PU | 1.4 | 33 | −94 | 91.9 (97.8) | 1.49 | +0.07 |

The data shown in Table 13 suggest that coatings prepared with fusing agent in the ink generally exhibited a lower average sheet resistance as compared to corresponding coatings without fusing agent. Differences in sheet resistance were greater for coatings prepared on PU as compared to COP. For example, S7 and S4 inks coated on COP exhibited a difference of −45 Ohms/sq, respectively, whereas the difference on PU was −94 Ohms/sq. All coatings exhibited a % TT of about 92%. Little to no change in % H was observed between inks with and without fusing agent, and overall, coatings prepared on PU were greater than those on COP.

### Example 8—Optical and Conductivity Performance of Inks Processed Under Ambient Conditions

This example further demonstrates optical performance and conductivity of ink coatings processed at ambient conditions.

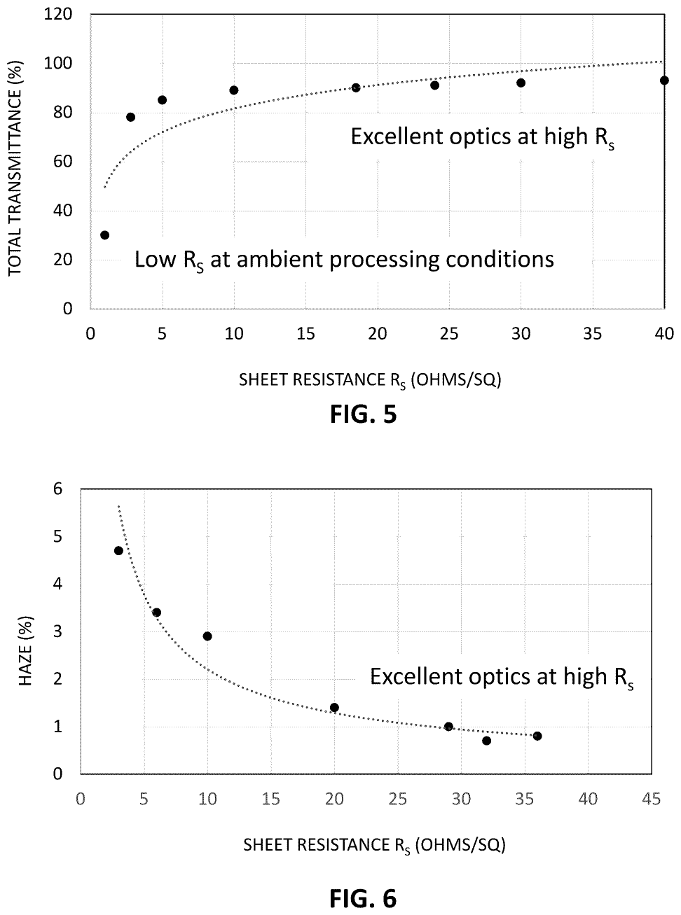

Inks of varied AgNW loadings were coated at different (4.0, 3.0, and 1.5 mil) gap thicknesses on COP to achieve a wide range of sheet resistances, and the samples were processed for about 1 min at ambient conditions. Selected performance structure and parenthetically for just the transparent conductive film (TCF). Results are shown in Table 14. Transmittance in Table 14 is reported for both the overall structure and parenthetically for just the transparent conductive film (TCF). Plots are shown in FIGS. 5 and 6.

TABLE 14

| | Average | | | | |
|---|---|---|---|---|---|
| | Sheet | | Sheet | Avg. | |
| | Resistance | Resistivity | Resistance/mil | % TT | Avg. |
| Ink | (Ohms/sq)¹ | (Ohms-cm) | ((Ohms/sq)/mil)² | (% TT TCF) | % H |
| S5- | 3 | 2.1 × 10⁻⁵ | 8.2 × 10⁻³ | >75 (>80) | <4.80 |
| H | | | | | |
| S5 | 10 | 6.9 × 10⁻⁵ | 2.7 × 10⁻² | >85 (>91) | <3.00 |
| S5 | 40 | 9.6 × 10⁻⁵ | 3.8 × 10⁻² | >92 (>98) | <0.55 |

¹Dried 1 minute, ambient conditions; on COP
²Estimate

The results indicate excellent optical properties in combination with desirable conductivity properties can be obtained for ink coatings dried at ambient conditions.

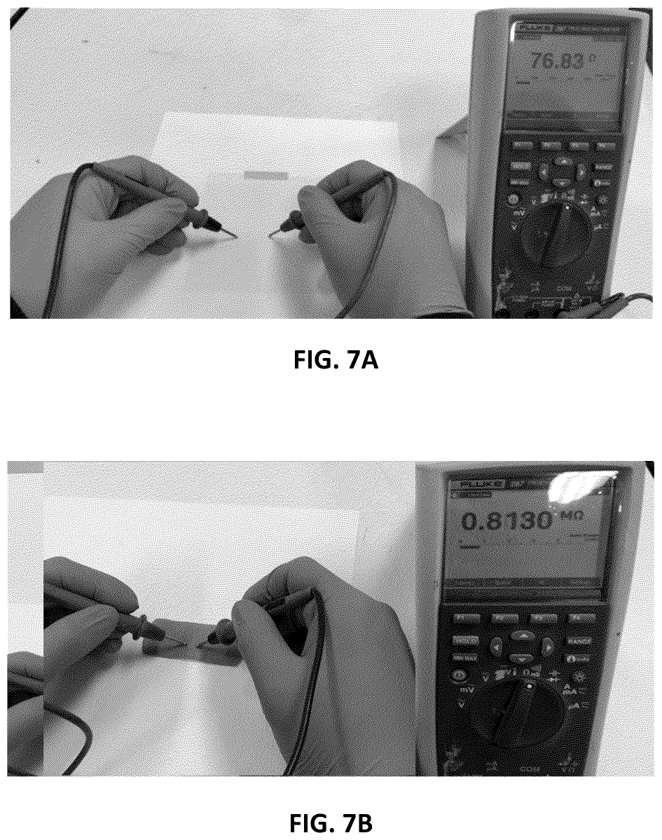

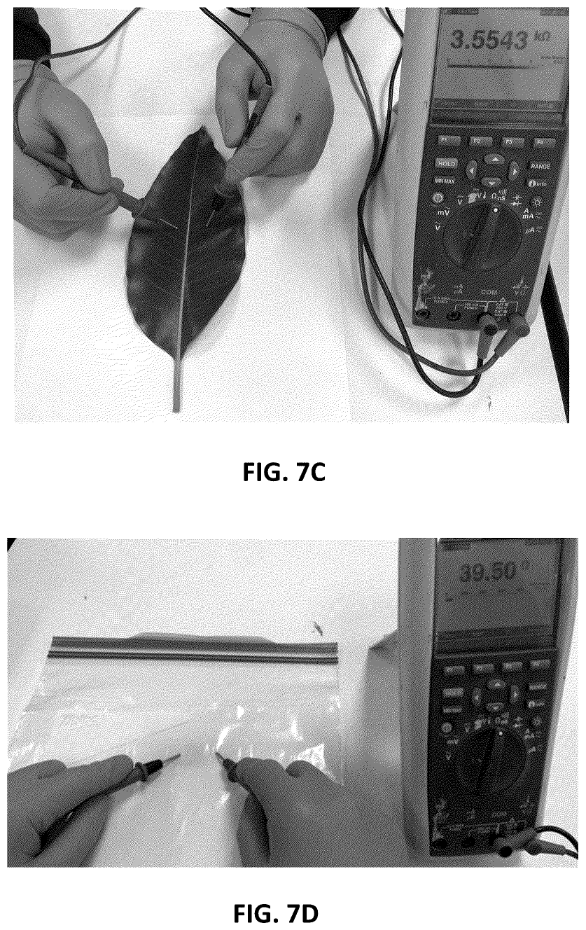

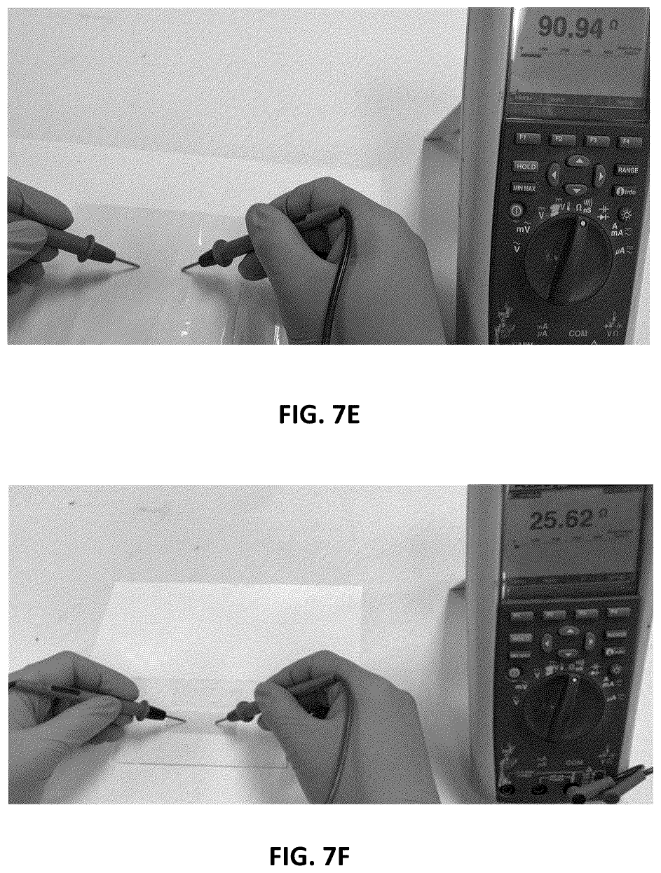

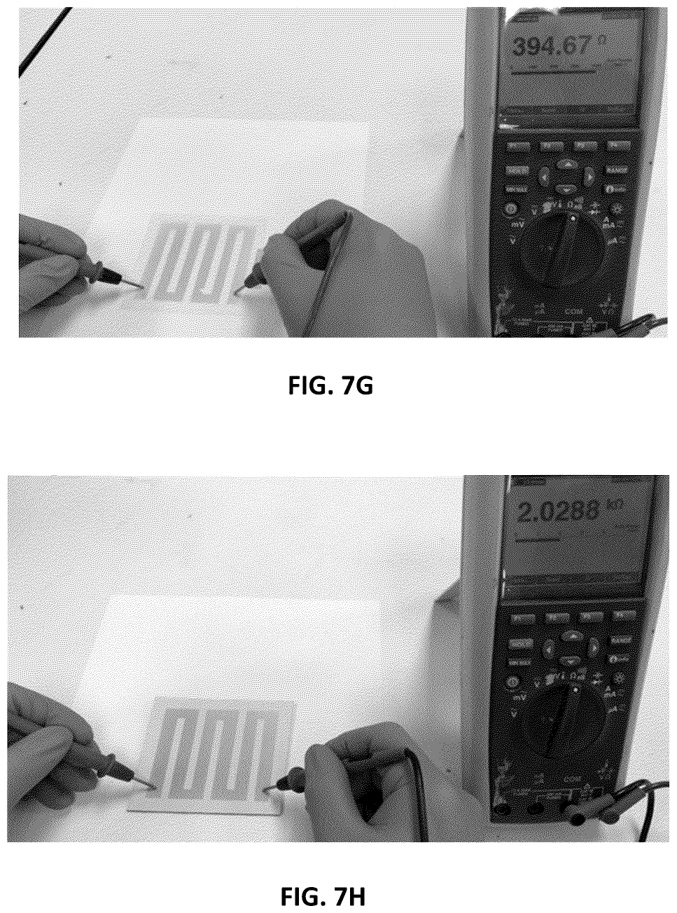

An ink comprising GEN5 nanowires and AgF was formed as a coating or a circuit on various substrates, including heat sensitive substrates, and dried under ambient conditions. The substrates included medical grade polyurethane, a medical bandage, a leaf, a Ziploc® bag, shrink wrap, Scotch™ Tape (coating on adhesive layer of the tape), PET and packaging cardboard. Resistance was measured by direct contact measurement as shown in FIGS. 7A-7H. While crude resistance measurements were attempted, obtaining accurate measurements for many of these substrates was not attempted and the nature of the substrate resulted in uncertainty.

### Example 9—High Alcohol Inks, Differences in AgF Ink Formulations

This example shows performance of inks prepared with alcohol as the main solvent as compared to water, as well as differences in performance related to the presence of a fluorosurfactant in the ink. In general, the cellulose used as binder is soluble in EtOH—H₂O mixture.

Inks with a high alcohol content were prepared with GEN5 ActiveGrid™ Ink in 80% ethanol in water. The inks were prepared with and without a non-ionic fluorosurfactant as wetting agent, and with and without AgF as fusing agent. Formulations are summarized in Table 15. S8-S11 inks were coated on hardcoated PET (described in Table 2) at a gap thickness of 1.5 mil. The coatings were dried at room temperature conditions with a fan blowing cool air at about 21° C. over the samples. Results are shown in Table 16. Transmittance in Table 16 is reported for both the overall structure and parenthetically for just the transparent conductive film (TCF).

TABLE 15

| Sample | ActiveGrid ™ | NanoGlue ® | |
|---|---|---|---|
| Set | Ink | Fusing Agent | Wetting Agent |
| S8 | GEN5 | none | none |
| S9 | GEN5 | AgF | none |
| S10 | GEN5 | none | fluorosurfactant¹ |
| S11 | GEN5 | AgF | fluorosurfactant¹ |

¹3M Novec ™ FC-4430 at 0.05 wt. %

TABLE 16

| | Average | | | |
|---|---|---|---|---|
| | Sheet | Average | | |
| | Resistance | % TT | Average | Average |
| Ink | (Ohms/sq) | (% TT TCF) | % H | b* |
| S8 | 84 | 92.4 (98.6) | 1.12 | |
| S8 | 58¹ | | | |
| S9 | 46 | 91.9 (98.1) | 1.12 | 1.5 |
| S10 | 900 | 92.0 (98.3) | 1.00 | 1.4 |
| S11 | 200 | 92.0 (98.3) | 1.00 | 1.4 |

¹Further heating at 120° C. for 5 minutes

For S8 and S9, which do not contain wetting agent, the sheet resistance dropped by 38 Ohms/sq if fusing agent was present, and little to no difference was observed for % TT, % H and b*. For S10 and S11, which contain wetting agent, the sheet resistance dropped by 700 Ohms/sq if fusing agent was present, and little to no difference was observed for % TT, % H and b*. However, sheet resistance was much greater for S10 and S11 as compared to S8 and S9, for example, 84 Ohms/sq for S8 versus 900 Ohms/sq for S10. The % TT, % H and b* were about the same for all coatings.

### Example 10—High Alcohol Inks, Addition of NaF

This example shows performance of inks prepared with alcohol as the main solvent as compared to water, as well as differences in performance related to the presence of an alkali fluoride salt in the ink.

Inks with a high alcohol content were prepared with GEN5 ActiveGrid™ Ink in 64-70% ethanol in water. The inks were prepared with AgOAc, AgF, NaF and a combination of equimolar AgOAc and NaF. Formulations are summarized in Table 17. S12-S16 inks were coated on HC-PET at a gap thickness of 1.5 mil. The coatings were processed differently as indicated in Table 17. Some coatings were dried at room temperature conditions with a fan blowing cool air at about 21° C. over the samples. After measurement of the sheet resistance of the resulting films, further heating for 2 min at 120° C. was applied to the samples. Results are shown in Tables 17-19. Transmittance in Table 19 is reported for both the overall structure and parenthetically for just the transparent conductive film (TCF).

TABLE 17

| | | | Average Sheet Resistance | |
|---|---|---|---|---|
| | NanoGlue ® | | (Ohms/sq) | |
| Ink | Fusing Agent | % Alcohol | cool air | 2 min, 120° C. |
| S12 | none | 70 | 70.0 | 48.7 |
| S13 | AgF | 69 | 35.3 | 36.3 |
| S14 | AgOAc | 65 | 65.7 | 36 |
| S15 | AgOAc + NaF | 64 | 70.7 | 44.3 |
| S16 | NaF | 69 | 60.0 | 49.7 |

TABLE 18

| | | Average | | | | | |
|---|---|---|---|---|---|---|---|
| | | % TT | | Average | | Average | |
| | NanoGlue ® | (% TT TCF) | | % H | | b* | |
| | Fusing | cool | 2 min, | cool | 2 min, | cool | 2 min, |
| Ink | Agent | air | 120° C. | air | 120° C. | air | 120° C. |
| S12 | none | 92.2 | 92.3 | 1.28 | 1.26 | 1.78 | 1.79 |
| | | (98.4) | (98.5) | | | | |
| S13 | AgF | 92.1 | 92.2 | 1.36 | 1.40 | 1.84 | 1.92 |
| | | (98.3) | (98.4) | | | | |
| S14 | AgOAc | 91.9 | 91.2 | 1.46 | 1.46 | 1.89 | 2.23 |
| | | (98.1) | (97.3) | | | | |
| S15 | AgOAc + | 91.5 | 92.3 | 1.31 | 1.43 | 1.13 | 1.62 |
| | NaF | (97.7) | (98.5) | | | | |
| S16 | NaF | 91.5 | 91.3 | 1.41 | 1.49 | 1.65 | 2.29 |
| | | (97.7) | (97.4) | | | | |

TABLE 19

| | | ΔSheet | | | |
|---|---|---|---|---|---|
| | NanoGlue ® | Resistance | | | |
| Ink | Fusing Agent | (Ohms/sq) | Δ% TT | Δ% H | Δb* |
| S12 | none | −21.3 | +0.1 | −0.02 | +0.01 |
| S13 | AgF | +1.0 | +0.1 | −0.04 | +0.08 |
| S14 | AgOAc | −29.7 | +0.3 | 0 | +0.34 |
| S15 | AgOAc + NaF | −26.4 | +0.8 | +0.12 | +0.49 |
| S16 | NaF | −10.3 | −0.2 | +0.08 | +0.64 |

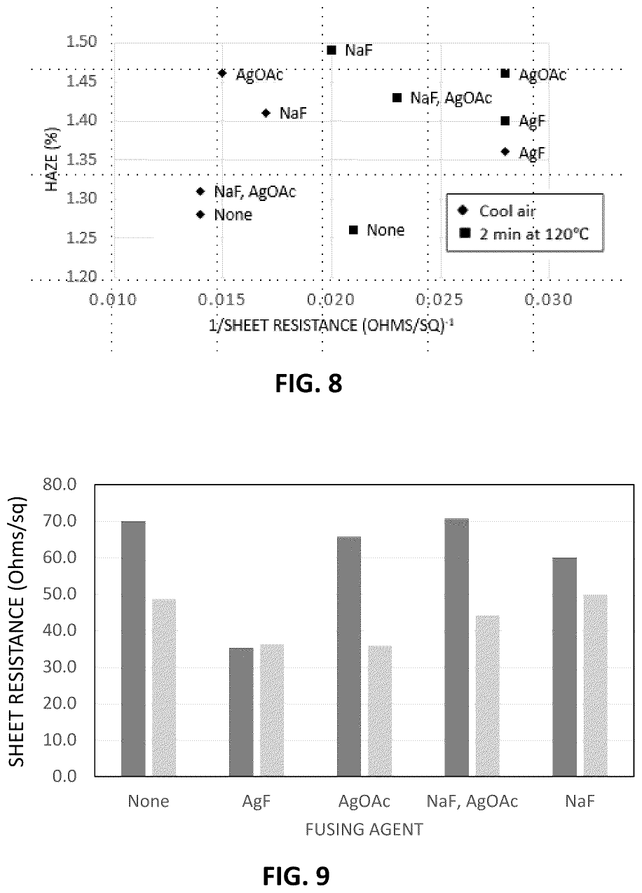

Data from Tables 17-19 are plotted in FIGS. 8 and 9. FIG. 8 shows the inverse of sheet resistance versus haze for S12-S16 processed under each of the conditions described above. FIG. 9 shows comparison of sheet resistance values obtained for coatings with the same fusing agents or without fusing agents. For S12-S16, the sheet resistance dropped by more than 10 Ohms/sq if the coatings were heated after drying at room temperature, except for S13, for which the sheet resistance remained about the same. S13 also gave the lowest sheet resistance. Little to no difference was observed for % TT and % H, however b* increased by about 0.3 to about 0.6 if heat was used. This example demonstrates that the fluoride anion alone at the level used is not driving the room temperature fusing. So the data suggests the sole combination of silver cation and fluoride anion is significant.

### Example 11—Performance of by-Product Silver Nanoparticulate Ink

This example demonstrates performance of inks prepared from silver by-products resulting from the synthesis of silver nanowires.

The by-product silver nanoparticulates mixture was recovered from the centrifugal residue of the purification process for production of GEN 5 silver nanowires.

Three samples were characterized using titration and thermogravimetric analyses (745° C.) and results are summarized in Table 21.

TABLE 20

| | Ag¹ | Ag² |
|---|---|---|
| By-Product | (%) | (%) |
| W1 | 0.97 | 1.17 |
| W2 | 0.98 | 1.06 |
| W3 | 0.707 | 5.61 |

¹Titration
²Thermogravimetric analysis

Ink S17 was formulated using the by-product W1 at 4× Ag loading and 1× cellulose binder, with AgF as fusing agent. Ink S18 was formulated with the same ratio of all components except that concentrations of all solids are approximately 60% higher than in Ink S17.

TABLE 21

| | Coating | | Sheet | | |
|---|---|---|---|---|---|
| | Thickness | Drying | Resistance | | |
| Ink | (mil) | Conditions | (Ohms/sq) | % T | % H |
| S17 | 1.5 | room temperature | 20-30 | 83.5 | 13.5 |
| S17 | 1.5 | 5 min, 120° C. | 20-25 | 84 | 5.5 |
| S17 | 2 | 5 min, 120° C. | 10-15 | 79 | 8.5 |
| S18 | 2 | 5 min, 120° C. | 4-6 | 67 | 12.5 |

Ink S19 was formulated using the by-product W2 (W1 filtered through a 400 mesh filter) at 4× Ag loading and 1× cellulose binder, with AgF as fusing agent. Ink S20 was formulated the same as ink S19 except no fusing agent was added.

TABLE 22

| | Coating | | Sheet | | |
|---|---|---|---|---|---|
| | Thickness | Drying | Resistance | | |
| Ink | (mil) | Conditions | (Ohms/sq) | % T | % H |
| S19 | 1.5 | room temperature | 16-18 | 82.5 | 5.8 |
| S19 | 1.5 | 5 min, 120° C. | 16-18 | 84.5 | 5.3 |
| S20 | 1.5 | room temperature | 45 | 83.5 | 5.6 |
| S20 | 1.5 | 5 min, 120° C. | 28-32 | 85.5 | 4.8 |

Ink S21 was formulated using the by-product W3 (W1 further concentrated by an aggregation step) at 4× Ag loading and 1× cellulose binder, with AgF as fusing agent.

TABLE 23

| | Coating | | Sheet | | |
|---|---|---|---|---|---|
| | Thickness | Drying | Resistance | | |
| Ink | (mil) | Conditions | (Ohms/sq) | % T | % H |
| S21 | 1.5 | 5 min, 120° C. | 15-18 | 86.0 | 3.7 |
| S21 | 1.5 | room temperature | 18-19 | 86.0 | 3.5-4.0 |

### Further Inventive Concepts

A1. A method for forming an electrically conductive coating with a very low sheet resistance, the method comprising:
applying a silver nanoparticulate ink to a substrate surface to form a wet coating, the ink comprising an aqueous solvent, silver nanoparticulates with no more than 85 wt % silver nanowires with an average diameter of 50 nm or less and an aspect ratio of 10 or more, and a cellulose binder; and
drying the wet coating at a temperature no more than 60° C. to form a dry coating having a sheet resistance of no more than 25 Ohms/sq.

A2. The method of further inventive concept A1 wherein the ink comprises a silver salt.

A3. The method of further inventive concept A1 wherein the ink comprises from 0.001 mg/mL and about 2.0 mg/mL silver ions and wherein after drying a fused silver nanostructure network is formed.

A4. The method of further inventive concept A2 wherein the silver salt comprises AgF.

A5. The method of further inventive concept A1 wherein the sheet resistance is less than about 20 Ohm/sq and the coating has a % TT at least about 50%.

A6. The method of further inventive concept A1 wherein the ink is formed from a solution used to synthesize the silver nanowires.

A7. The method of further inventive concept A1 wherein the inert surface is a surface of a polymeric substrate.

A8. The method of further inventive concept A1 wherein the ink is free of added metal salt.

A9. The method of further inventive concept A1 wherein the ink comprises from about 30 wt % to about 80 wt % silver nanowires relative to the total silver nanoparticles.

A10. The method of further inventive concept A1 wherein the ink comprises a solvent having greater than 51 volume percent alcohol and is free of a fluorosurfactant.

B1. A silver nanoparticulate ink comprising an aqueous solvent, silver nanoparticulates comprising no more than 85 wt % silver nanowires with an average diameter of 50 nm or less and an aspect ratio of 10 or more, and a cellulose binder, wherein the weight ratio of cellulose to silver nanoparticulates is from about 0.05 to about 3.

B2. The ink of further inventive concept B1 wherein the ink comprises from about 0.001 wt % to about 4 wt % silver nanowires and from about 0.05 wt % to about 5 wt % of a hydroxy alkyl-functionalized polymeric binder, aqueous solvent comprising from about 20 vol % to about 100 vol % of a C₁ to C₁₀ alcohol, and no more than about 0.001 wt % of a surfactant.

B3. The ink of further inventive concept B1 wherein the cellulose binder comprises a hydroxy alkyl-functionalized polymeric binder.

B4. The ink of further inventive concept B1 wherein the cellulose binder comprises a hydroxy alkyl-functionalized polymeric binder, an alkyl cellulose, a hydroxyalkyl cellulose or a mixture thereof.

B5. The ink of further inventive concept B1 wherein the ink further comprises from 0.001 mg/mL and about 2.0 mg/mL silver ions.

B6. The ink of further inventive concept B1 wherein the ink further comprises a silver salt.

B7. The ink of further inventive concept B6 wherein the silver salt comprises AgOAc or AgF.

B8. The ink of further inventive concept B6 wherein silver ions from the silver salt are present in an amount from about 0.001 mg/mL and about 2.0 mg/mL.

B9. The ink of further inventive concept B1 wherein the silver nanoparticles are provided in the form of a solution used for the synthesis of silver nanowires.

B10. The ink of further inventive concept B1 wherein the silver nanowires have a noble metal coating.

B11. The ink of further inventive concept B2 wherein the C₁ to C₁₀ alcohol comprises a C₁ to C₅ alcohol.

B12. The ink of further inventive concept B2 wherein the ink is free of fluorosurfactant.

B13. The ink of further inventive concept B1 wherein the silver nanoparticulates further comprise spherical nanoparticles, nanorods, nanoplates, nanocubes, odd shaped nanoparticles or a mixture thereof.

B14. The ink of further inventive concept B1 wherein the silver nanoparticulates further comprise silver nanowires having an average diameter greater than 50 nm.

B15. The ink of further inventive concept B1 wherein the silver nanoparticulates comprise from about 30 wt % to about 80 wt % silver nanowires and the ink has from about 0.2 wt % to about 3 wt % silver nanoparticles.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to expected uncertainties in the associated values as would be understood in the particular context by a person of ordinary skill in the art.

What is claimed is:

1. A method for forming a conductive layer comprising:
depositing a metal nanowire ink onto an inert surface to form a coating, the ink comprising from about 0.001 wt % to about 4 wt % metal nanowires and from about 0.05 wt % to about 5 wt % polysaccharide; and
drying the coating at room temperature to form a conductive film having a sheet resistance of no more than about 1000 Ohms/sq.

2. The method of claim 1, wherein the metal nanowires comprise silver nanowires and the metal nanowire ink comprises a silver salt.

3. The method of claim 1, wherein the metal nanowire ink comprises from 0.001 mg/mL and about 2.0 mg/mL silver ions and wherein after drying a fused metal nanostructure network is formed.

4. The method of claim 2, wherein the silver salt comprises AgF.

5. The method of claim 1, wherein the sheet resistance is less than about 100 Ohm/sq and the coating has a % TT at least about 98.6%.

6. The method of claim 1, wherein the sheet resistance is less than about 100 Ohm/sq.

7. The method of claim 1, wherein the inert surface is a surface of a polymeric substrate and the substrate with the coating forms a conductive film exhibiting a total transmission of at least about 90%, a haze of less than about 1.0%, and a b* of less than about 2.0.

8. The method of claim 1 wherein the metal nanowire ink is free of added metal salt.

9. The method of claim 8 wherein the inert surface is a surface of a polymeric substrate and the substrate with the coating forms a conductive film exhibiting a percent total transmission of at least about 90%, a haze of less than about 1.0%, and a b* of less than about 1.0.

10. An ink for forming a conductive layer, the ink comprising from about 0.001 wt % to about 4 wt % metal nanowires and from about 0.05 wt % to about 5 wt % of a hydroxy alkyl-functionalized polymeric binder, aqueous solvent comprising from about 20 vol % to about 100 vol % of a C₁ to C₁₀ alcohol, and no more than about 0.001 wt % of a surfactant.

11. The ink of claim 10 wherein the hydroxy alkyl-functionalized polymeric binder comprises cellulose.

12. The ink of claim 10 wherein the hydroxy alkyl-functionalized polymeric binder comprises an alkyl cellulose, a hydroxyalkyl cellulose or a mixture thereof.

13. The ink of claim 10 wherein the ink further comprises from 0.001 mg/mL and about 2.0 mg/mL metal ions.

14. The ink of claim 10 wherein the metal nanowires comprise silver nanowires.

15. The ink of claim 14 wherein the ink further comprises a silver salt.

16. The ink of claim 15 wherein the silver salt comprises AgOAc or AgF.

17. The ink of claim 16 wherein silver ions from the silver salt is present in an amount of from 0.001 mg/mL and about 2.0 mg/mL.

18. The ink of claim 10 wherein the metal nanowires have an average diameter of 25 nm or less.

19. The ink of claim 10 wherein the metal nanowires have an average diameter of 20 nm or less.

20. The ink of claim 10 wherein the metal nanowires have an average diameter of 15 nm or less.

21. The ink of claim 10 wherein the metal nanowires have a noble metal coating.

22. The ink of claim 10 wherein the C₁ to C₁₀ alcohol comprises a C₁ to C₅ alcohol.

23. The ink of claim 10 wherein the surfactant comprises a non-ionic surfactant.

24. The ink of claim 10 wherein the surfactant comprises a fluorinated surfactant.
